(19) United States
(12) Patent Application Publication
(10) Pub. No.: US 2024/0422708 A1
(43) Pub. Date: Dec. 19, 2024

(54) COMPENSATING ESTIMATES FOR CLOCK DRIFT AND TIMING ADJUSTMENTS

(71) Applicant: TELEFONAKTIEBOLAGET LM ERICSSON (PUBL), Stockholm (SE)

(72) Inventors: Per ERNSTRÖM, STOCKHOLM (SE); Siva MURUGANATHAN, STITTSVILLE (CA)

(21) Appl. No.: 18/701,689

(22) PCT Filed: Nov. 4, 2022
(86) PCT No.: PCT/IB2022/060653

§ 371 Date: Apr. 16, 2024

Related U.S. Application Data
(60) Provisional application No. 63/276,293, filed on Nov. 5, 2021.

(51) Int. Cl. H04W 56/00; H04L 5/00

(52) U.S. Cl. CPC H04W 56/004; H04L 5/0005

(57) ABSTRACT

Systems and methods for configuring and performing compensation for UE clock drifts and/or UE timing adjustments for RTT estimations. A wireless device can receive, from a network node, configuration information associated with estimating and reporting transmission timing compensation. The wireless device can estimate a transmission timing compensation for a time interval and report it to the network node. The network node can estimate a round trip time and/or a position of the wireless device based at least in part on the estimated transmission timing compensation.

### CROSS REFERENCE TO RELATED APPLICATIONS

This application claims the benefit of U.S. Provisional Application No. 63/276,293 filed on Nov. 5, 2021, the entire contents of which are hereby incorporated by reference.

### TECHNICAL FIELD

The present disclosure generally relates to wireless communications and wireless communication networks.

### INTRODUCTION

Standardization bodies such as Third Generation Partnership Project (3GPP) are studying potential solutions for efficient operation of wireless communication in new radio (NR) networks. The next generation mobile wireless communication system 5G/NR will support a diverse set of use cases and a diverse set of deployment scenarios. The later includes deployment at both low frequencies (e.g. 100s of MHz), similar to LTE today, and very high frequencies (e.g. mm waves in the tens of GHz). Besides the typical mobile broadband use case, NR is being developed to also support machine type communication (MTC), ultra-low latency critical communications (URLCC), side-link device-to-device (D2D) and other use cases.

Positioning and location services have been topics in LTE standardization since 3GPP Release 9. An objective was to fulfill regulatory requirements for emergency call positioning but other use case like positioning for Industrial Internet of Things (I-IoT) are also considered. Positioning in NR is supported by the example architecture shown in FIG. 1. LMF 108A represents the location management function entity in NR. There are also interactions between the LMF 108A and the gNodeB 110 via the NRPPa protocol. The interactions between the gNodeB 110 and the device (UE) 112 are supported via the Radio Resource Control (RRC) protocol, while the location node 108A interfaces with the UE 112 via the LTE positioning protocol (LPP). LPP is common to both NR and LTE technologies. Other network nodes, such as Access and Mobility Management Function (AMF) 108B and evolved Serving Mobile Location Center (e-SMLC) 108C, may be involved in positioning support.

It will be appreciated that while FIG. 1 shows gNB 110B and ng-eNB 110A, both may not always be present. It is noted that when both the gNB 110B and ng-eNB 110A are present, the NG-C interface is generally only present for one of them.

In the legacy LTE standards, the following techniques are supported:
Enhanced Cell ID. Essentially cell ID information to associate the device to the serving area of a serving cell, and then additional information to determine a finer granularity position.
Assisted Global Navigation Satellite System (GNSS). GNSS information retrieved by the device, supported by assistance information provided to the device from E-SMLC
OTDOA (Observed Time Difference of Arrival). The device estimates the time difference of reference signals from different base stations and sends to the E-SMLC for multilateration.
UTDOA (Uplink TDOA). The device is requested to transmit a specific waveform that is detected by multiple location measurement units (e.g. an eNB) at known positions. These measurements are forwarded to E-SMLC for multilateration.

NR positioning since Release 16, based on the 3GPP NR radio-technology, has provided added value in terms of enhanced location capabilities. The operation in low and high frequency bands (i.e. below and above 6 GHz) and utilization of massive antenna arrays provide additional degrees of freedom to substantially improve the positioning accuracy. The possibility to use wide signal bandwidth in low and especially in high bands brings new performance bounds for user location for well-known positioning techniques based on OTDOA and UTDOA, Cell-ID or E-Cell-ID etc., utilizing timing measurements to locate a UE.

In NR Release 16, several positioning features have been specified including reference signals, measurements, and positioning methods.

Reference signals:
A new downlink (DL) reference signal, the NR DL Positioning Reference Signal (PRS) was specified. A benefit of this signal in relation to the LTE DL PRS is the increased bandwidth, configurable from 24 to 272 RBs, which gives a big improvement in Time of Arrival (TOA) accuracy. The NR DL PRS can be configured with a comb factor of 2, 4, 6 or 12. Comb-12 allows for twice as many orthogonal signals as the comb-6 LTE PRS. Beam sweeping is also supported on NR DL PRS in Rel-16.
A new uplink (UL) reference signal, based on the NR UL Sounding Reference Signal (SRS) was introduced and called “SRS for positioning”. The Release 16 NR SRS for positioning allows for a longer signal, up to 12 symbols (compared to 4 symbols in Rel. 15 SRS), and a flexible position in the slot (only last six symbols of the slot can be used in Rel. 15 SRS). It also allows for a staggered comb resource element (RE) pattern for improved TOA measurement range and for more orthogonal signals based on comb offsets (comb 2, 4 and 8) and cyclic shifts. The use of cyclic shifts longer than the Orthogonal Frequency Division Multiplexed (OFDM) symbol divided by the comb factor is, however, not supported by Rel. 16 despite that this is the main advantage of comb-staggering at least in indoor scenarios. Power control based on neighbor cell Synchronization Signal Block (SSB)/DL PRS is supported as well as spatial Quasi-CoLocation (QCL) relations towards a Channel State Reference Signal (CSI-RS), an SSB, a DL PRS or another SRS.

### Positioning Techniques

NR positioning supports the following methods:

Methods already in LTE and enhanced in NR:
DL TDOA (downlink TDOA)
E-CID
RAT independent methods (based on non-3GPP sensors such as GPS, pressure sensors, Wifi signals, Bluetooth, etc).
UL TDOA (uplink TDOA)

Newly introduced methods in NR:
Multicell RTT: the LMF collects RTT (round trip time) measurement as the basis for multilateration
DL angle of departure (AoD) and UL angle of arrival (AoA), where multilateration is done using angle and power (RSRP) measurements

### Measurements:

In NR Rel. 16, the following UE measurements are specified:
DL Reference Signal Time Difference (RSTD), allowing for e.g. DL TDOA positioning
Multi cell UE Rx-Tx Time Difference measurement, allowing for multi-cell round trip time (RTT) measurements
DL PRS Reference Signal Receive Power (RSRP)

In NR Rel. 16, the following gNB measurements are specified:
Uplink Relative Time of Arrival (UL-RTOA), useful for UL TDOA positioning
gNB Rx-Tx time difference, useful for multi cell RTT measurements
UL SRS-RSRP
Angle of Arrival (AoA) and Zenith angle of Arrival (ZoA)

In NR Release 17, discussions are ongoing to specify and standardize NR positioning enhancements in NR release 17 within the 3GPP work item 'NR positioning enhancements' [RP-202900]. One of the objectives is to specify methods, measurements, signaling, and procedures for improving positioning accuracy of the Rel-16 NR positioning methods by mitigating UE Rx/Tx and/or gNB Rx/Tx timing delays, including: DL, UL and DL+UL positioning methods; and/or UE-based and UE-assisted positioning solutions.

Within this work, discussions are ongoing for how consider UE TX timing adjustments (TAs) when performing RTT estimates based on UE Rx-Tx time difference measurements and gNB Rx-Tx time difference measurements.

### NR Rel-16 UE/gNB Rx-Tx Time Difference Measurements

In NR Rel-16, the UE Rx-Tx time different measurement is defined as follows (3GPP TS 38.215 V16.4.0):

| | |
|---|---|
| Definition | The UE Rx − Tx time difference is defined as T_{UE-RX} − |
| | T_{UE-TX} |
| | Where: |
| | T_{UE-RX} is the UE received timing of downlink subframe #i |
| | from a Transmission Point (TP) [18], defined by the |
| | first detected path in time. |
| | T_{UE-TX} is the UE transmit timing of uplink subframe #j |
| | that is closest in time to the subframe #i received from the TP. |
| | Multiple DL PRS resources can be used to determine the |
| | start of one subframe of the first arrival path of the TP. |
| | For frequency range 1, the reference point for T_{UE-RX} |
| | measurement shall be the Rx antenna connector of the |
| | UE and the reference point for T_{UE-TX} measurement shall |
| | be the Tx antenna connector of the UE. For frequency |
| | range 2, the reference point for T_{UE-RX} measurement |
| | shall be the Rx antenna of the UE and the reference |
| | point for T_{UE-TX} measurement shall be the Tx antenna |
| | of the UE. |
| Applicable | RRC_CONNECTED |
| for | |

Note that the transmit time in the Rel-16 measurement definition is the UE transmit timing of the uplink subframe #j that is closest in time to the downlink subframe #i, and not necessarily the transmit timing of the UL SRS.

In NR Rel-16, the gNB Rx-Tx time different measurement is defined as follows (3GPP TS 38.215 V16.4.0):

| | |
|---|---|
| Definition | The gNB Rx − Tx time difference is defined as T_{gNB-RX} − |
| | T_{gNB-TX} |
| | Where: |
| | T_{gNB-RX} is the Transmission and Reception Point (TRP) [18] |
| | received timing of uplink subframe #i containing SRS |
| | associated with UE, defined by the first detected path in time. |
| | T_{gNB-TX} is the TRP transmit timing of downlink subframe #j |
| | that is closest in time to the subframe #i received from |
| | the UE. |
| | Multiple SRS resources for positioning can be used to |
| | determine the start of one subframe containing SRS. |
| | The reference point for T_{gNB-RX} shall be: |
| | for type 1-C base station TS 38.104 [9]: the Rx antenna |
| | connector, |
| | for type 1-O or 2-O base station TS 38.104 [9]: the |
| | Rx antenna (i.e. the centre location of the radiating |
| | region of the Rx antenna), |
| | for type 1-H base station TS 38.104 [9]: the Rx |
| | Transceiver Array Boundary connector. |
| | The reference point for T_{gNB-TX} shall be: |
| | for type 1-C base station TS 38.104 [9]: the Tx antenna |
| | connector, |
| | for type 1-O or 2-O base station TS 38.104 [9]: the |
| | Tx antenna (i.e. the centre location of the radiating |
| | region of the Tx antenna), |
| | for type 1-H base station TS 38.104 [9]: the Tx |
| | Transceiver Array Boundary connector. |

An RTT estimate can be calculated as the ‘gNB RX-TX time difference’ minus the ‘UE RX-TX time difference’ by the LMF (note that the ‘gNB RX-TX time difference’ and the ‘UE RX-TX time difference’ measurements are reported to the LMF by the gNB and the UE, respectively). The measurements give the subframe timing difference between UL and DL frames at the gNB and the UE respectively as illustrated in FIG. 2.

FIG. 2 is an illustration of an RTT estimate calculated as the ‘gNB RX-TX time difference’ minus the ‘UE RX-TX time difference’. The measurements give the subframe timing difference between UL and DL frames at the gNB and the UE, respectively. The UE Rx frame timing is estimated using a reference signal such as the DL PRS. The gNB Rx frame timing is estimated using a reference signal such as the UL SRS. In the figure, the Rx-Tx time differences and propagation times have been made much larger than in reality for pedagogic reasons.

Transmission timing is defined in 3GPP TS 38.133:

The uplink frame transmission takes place (N_{TA}+N_{TA offset})×T_{c} before the reception of the first detected path (in time) of the corresponding downlink frame from the reference cell. For serving cell(s) in pTAG, UE shall use the SpCell as the reference cell for deriving the UE transmit timing for cells in the pTAG. For serving cell(s) in sTAG, UE shall use any of the activated SCells as the reference cell for deriving the UE transmit timing for the cells in the sTAG.

One may note here that if there is no carrier aggregation (CA) or dual connectivity (DC) the reference cell is simply the single serving cell. In case of CA/DC the reference cell is one of the serving cells.

The RAN4 requirements for TX timing are very relaxed but in practice the accuracy is much better or at least the drift with time is typically small.

To keep track of uplink frame timing the UE typically tunes an oscillator to the RX frequency of the reference cell (using e.g. the CSI-RS for tracking transmitted from the reference cell for tuning) and use that oscillator as a UE clock. In addition, the UE regularly measures the time of arrival of the first path (again using e.g. the CSI-RS for tracking) to check the uplink frame timing relative to the DL frame timing. If a deviation from the stipulated relative timing is seen, then an autonomous timing adjustment of the UL frame timing is performed in accordance with rules described in 3GPP TS 38.133. The UE also adjusts the UL frame timing after receiving a TA command, changing N_{TA}.

The required accuracy of the uplink frame transmission timing is very low. It may deviate with ±Tₑ around the stipulated offset of (N_{TA}+N_{TA offset})×T_{c}, where Tₑ is between 3·64·T_{c}≈98 ns and 12·64·T_{c}≈391 ns depending on subcarrier spacing. These requirements have been set based on the initial frame timing e.g. after a DRX cycle under the assumption that there has been a SSB available to the UE within the previous 160 ms. One may note that if it's not initial frame timing and the UE is using a full bandwidth TRS (CSI-RS for tracking) to track frequency and time, the UE should be able to follow the stipulated frame timing with extremely much better precision. There are, however, no such requirements.

Tuning to the DL frequency means that the UE clock is affected by doppler shifts in such a way that it compensates for the movements of the UE to keep the UL TX frame timing relative to the DL RX frame timing constant even though the propagation time changes. Still, due to imperfect tuning and/or disruptive channel events, such as blocking of the first path or unblocking of a new first path, the TX UL frame timing relative to the DL RX frame timing does change, eventually resulting in timing adjustments.

UE movements and the corresponding change in propagation time also result in misalignment of RX UL frames at the gNB, triggering the gNB to send a TA command to the UE.

A change in TX UL frame timing means a change in UL TX frame timing relative to the DL RX frame timing of the reference cell (as defined in 3GPP TS 38.133—not positioning reference cell). There are four types of such changes:
1. Timing adjustments due to a TA command from the gNB
2. Changes due to disruptive channel events, such as blocking of the first path or unblocking of a new first path in the channel of the reference cell
3. Changes due to imperfect tuning to the RX DL from the reference cell or drift of the UE oscillator frequency between DL frequency estimates used for tuning
4. Autonomous timing adjustments to correct for changes of type 2 or type 3 above, once detected by the UE

Type 2 and type 3 changes are not known by the UE until at some point the UE measures the TOA of the first path of the reference cell. When such a change is discovered the UE compensates for that change by performing a type 4 timing adjustment. According to requirements, adjustments are only needed to the extent that the deviation is kept within ±Tₑ around the stipulated offset of (N_{TA}+N_{TA offset})×T_{c}.

In 3GPP TS 38.133 v3.7.0 UE transmit timing and timing adjustments are described in section 7.1:

### 7.1 UE Transmit Timing

### 7.1.1 Introduction

The UE shall have capability to follow the frame timing change of the reference cell in connected state. The uplink frame transmission takes place (N_{TA}+N_{TA offset})×T_{c} before the reception of the first detected path (in time) of the corresponding downlink frame from the reference cell. For serving cell(s) in pTAG, UE shall use the SpCell as the reference cell for deriving the UE transmit timing for cells in the pTAG. For serving cell(s) in sTAG, UE shall use any of the activated SCells as the reference cell for deriving the UE transmit timing for the cells in the sTAG. UE initial transmit timing accuracy and gradual timing adjustment requirements are defined in the following requirements.

In the requirements of clause 7.1.2, the term reference cell on a carrier frequency subject to CCA is not available at the UE refers to when at least one SSB is configured by gNB, but the first two successive candidate SSB positions for the same SSB index within the discovery burst transmission window are not available during at least one discovery burst transmission window, at the UE due to DL CCA failures at gNB during the last 1280 ms; otherwise the reference cell on the carrier frequency subject to CCA is considered as available at the UE.

### 7.1.2 Requirements

The UE initial transmission timing error shall be less than or equal to ±Tₑ where the timing error limit value Tₑ is specified in Table 7.1.2-1. This requirement applies:
when it is the first transmission in a DRX cycle for PUCCH, PUSCH and SRS, or it is the PRACH transmission, or it is the msgA transmission.

The UE shall meet the Te requirement for an initial transmission provided that at least one SSB is available at the UE during the last 160 ms. The reference point for the UE initial transmit timing control requirement shall be the downlink timing of the reference cell minus (N_{TA}+N_{TA offset})×T_{c}. The downlink timing is defined as the time when the first detected path (in time) of the corresponding downlink frame is received from the reference cell. N_{TA} for PRACH is defined as 0.

(N_{TA}+N_{TA offset})×T_{c} (in T_{c} units) for other channels is the difference between UE transmission timing and the downlink timing immediately after when the last timing advance in clause 7.3 was applied. N_{TA} for other channels is not changed until next timing advance is received. The value of N_{TA offset} depends on the duplex mode of the cell in which the uplink transmission takes place and the frequency range (FR). N_{TA offset} is defined in Table 7.1.2-2.

TABLE 7.1.2-1
Tₑ Timing Error Limit

| Frequency | SCS of SSB | SCS of uplink | |
|---|---|---|---|
| Range | signals (kHz) | signals (kHz) | Tₑ |
| 1 | 15 | 15 | 12*64*T_{c} |
| | | 30 | 10*64*T_{c} |
| | | 60 | 10*64*T_{c} |
| | 30 | 15 | 8*64*T_{c} |
| | | 30 | 8*64*T_{c} |
| | | 60 | 7*64*T_{c} |
| 2 | 120 | 60 | 3.5*64*T_{c} |
| | | 120 | 3.5*64*T_{c} |
| | 240 | 60 | 3*64*T_{c} |
| | | 120 | 3*64*T_{c} |

Note 1:
T_{c} is the basic timing unit defined in TS 38.211

TABLE 7.1.2-2
The Value of N_{TA offset}

| Frequency range and band of cell | N_{TA offset} | |
|---|---|---|
| used for uplink transmission | (Unit: T_{c}) | |
| FR1 FDD or TDD band with neither E-UTRA-NR | 25600 | (Note 1) |
| nor NB-IoT-NR coexistence case | | |
| FR1 FDD band with E-UTRA-NR and/or | 0 | (Note 1) |
| NB-IoT-NR coexistence case | | |
| FR1 TDD band with E-UTRA-NR and/or | 39936 | (Note 1) |
| NB-IoT-NR coexistence case | | |

| | |
|---|---|
| FR2 | 13792 |

Note 1:
The UE identifies N_{TA offset} based on the information n-TimingAdvanceOffset as specified in TS 38.331 . If UE is not provided with the information n-TimingAdvanceOffset, the default value of N_{TA offset} is set as 25600 for FR1 band. In case of multiple UL carriers in the same TAG, UE expects that the same value of n-TimingAdvanceOffset is provided for all the UL carriers according to clause 4.2 in TS 38.213 and the value 39936 of N_{TA offset} can also be provided for a FDD serving cell.
Note 2:
Void

When it is not the first transmission in a DRX cycle or there is no DRX cycle, and when it is the transmission for PUCCH, PUSCH and SRS transmission, the UE shall be capable of changing the transmission timing according to the received downlink frame of the reference cell except when the timing advance in clause 7.3 is applied.

### Table 7.1.2-3: Void

If the UE uses a reference cell on a carrier frequency subject to CCA for deriving the UE transmit timing, then the UE shall meet all the transmit timing requirements defined in clause 7.1.2 provided that the reference cell is available at the UE. If the reference cell is not available at the UE on a carrier frequency subject to CCA, then the UE is allowed to transmit in the uplink provided that the UE meets all the transmit timing requirements defined in clause 7.1.2; otherwise the UE shall not transmit any uplink signal.

If a reference cell on a carrier frequency belonging to the PTAG, which is subject to CCA, is not available at the UE then the UE is allowed to use any of available activated SCell(s) at the UE in PTAG as a new reference cell. If the SCell used as reference cell is deactivated, or becomes not available, the UE is allowed to use another active serving cell in PTAG as new reference cell.

If a reference cell on a carrier frequency belonging to the STAG, which is subject to CCA is not available at the UE then the UE is allowed to use any of available activated SCell(s) at the UE in STAG as a new reference cell.

### 7.1.2.1 Gradual Timing Adjustment

Requirements in this section shall apply regardless of whether the reference cell is on a carrier frequency subject to CCA or not.

When the transmission timing error between the UE and the reference timing exceeds ±Tₑ then the UE is required to adjust its timing to within ±Tₑ. The reference timing shall be (N_{TA}+N_{TA offset})×T_{c} before the downlink timing of the reference cell. All adjustments made to the UE uplink timing shall follow these rules:
1) The maximum amount of the magnitude of the timing change in one adjustment shall be T_{q}.
2) The minimum aggregate adjustment rate shall be Tₚ per second.
3) The maximum aggregate adjustment rate shall be T_{q} per 200 ms.
   where the maximum autonomous time adjustment step T_{q} and the aggregate adjustment rate Tₚ are specified in Table 7.1.2.1-1.

TABLE 7.1.2.1-1
T_{q} Maximum Autonomous Time Adjustment Step
and Tₚ Minimum Aggregate Adjustment rate

| | SCS of uplink | | |
|---|---|---|---|
| Frequency Range | signals (kHz) | T_{q} | Tₚ |
| 1 | 15 | 5.5*64*T_{c} | 5.5*64*T_{c} |
| | 30 | 5.5*64*T_{c} | 5.5*64*T_{c} |
| | 60 | 5.5*64*T_{c} | 5.5*64*T_{c} |
| 2 | 60 | 2.5*64*T_{c} | 2.5*64*T_{c} |
| | 120 | 2.5*64*T_{c} | 2.5*64*T_{c} |

NOTE:
T_{c} is the basic timing unit defined in TS 38.211

Further consideration for timing adjustments when performing RTT estimates are needed.

### SUMMARY

It is an object of the present disclosure to obviate or mitigate at least one disadvantage of the prior art.

There are provided systems and methods for configuring and performing compensation for UE clock drifts and/or UE timing adjustments for RTT estimations.

In a first aspect there is provided a method performed by a wireless device. The wireless device can comprise a radio interface and processing circuitry and be configured to receive configuration information associated with estimating and reporting transmission timing compensation. The wireless device estimating a transmission timing compensation for a time interval in accordance with the configuration information. The wireless device transmits a report including the estimated transmission timing compensation.

In some embodiments, the configuration information includes an indication of the time interval for estimating the transmission timing compensation. The indicated time interval can be a time interval between a reception of a downlink (DL) positioning reference signal (PRS) and a transmission of an uplink (UL) sounding reference signal (SRS) by the wireless device. The configuration information can further include an indication of at least one SRS resource the wireless device should use for identifying the time interval for estimating the transmission timing compensation. The indication of the at least one SRS resource can include an SRS resource or a list of SRS resources associated with each target transmission/reception point (TRP).

In some embodiments, the wireless device can identify that the time interval for estimating the transmission timing compensation is a time interval between a reception of a DL PRS and a transmission of a UL SRS by the wireless device. This identification can be based at least in part on the received configuration information.

In some embodiments, the wireless device can further determine a UE Rx-Tx time difference measurement based on a reception time of a DL PRS. The transmitted report can also include the determined UE Rx-Tx time difference measurement.

In some embodiments, the time interval for estimating the transmission timing compensation is a time interval between the reception of the DL PRS used for UE Rx-Tx time difference measurement and a transmission time of a UL SRS. In some embodiments, the configuration information can indicate that the wireless device, responsive to determining a UE Rx-Tx time difference measurement based on the DL PRS, estimates the transmission timing compensation for the UE Rx-Tx time difference measurement and the associated SRS resource.

In some embodiments, the wireless device estimates and/or reports a plurality of transmission timing compensations between a DL PRS resource and a plurality of UL SRS transmission instances.

In some embodiments, estimating the transmission timing compensation includes estimating a difference in transmission timing between an end of the time interval and a start of the time interval. In some embodiments, the transmission timing compensation is estimated based on at least one of: a transmission timing adjustment made within the time interval, and/or a transmission timing estimate made within the time interval.

In some embodiments, the wireless device can further estimate an accuracy associated with the estimated transmission timing compensation. The wireless device can report the estimated accuracy.

In another aspect there is provided a method performed by a network node. The network node can be a core network node or an access network node as described herein. The network node can comprise a radio interface and processing circuitry and be configured to transmit, to a wireless device, configuration information associated with estimating and reporting transmission timing compensation. The network node receives, from the wireless device, a transmission timing compensation for a time interval. The network node estimates a round trip time (RTT) based at least in part on the received transmission timing compensation.

In some embodiments, the configuration information includes an indication of the time interval for estimating the transmission timing compensation. The indicated time interval can be a time interval between a reception of a downlink (DL) positioning reference signal (PRS) and a transmission of an uplink (UL) sounding reference signal (SRS) by the wireless device. The configuration information can further include an indication of at least one SRS resource the wireless device should use for identifying the time interval for estimating the transmission timing compensation. The indication of the at least one SRS resource can include an SRS resource or a list of SRS resources associated with each target transmission/reception point (TRP).

In some embodiments, the network node receives at least one of: a UE Rx-Tx time difference measurement, and/or a gNB Rx-Tx time difference measurement. The UE Rx-Tx time difference measurement can be received from the wireless device. The gNB Rx-Tx time difference measurement can be received from an access node (e.g. TRP).

In some embodiments, the network node estimates the RTT based at least in part on the gNB Rx-Tx time difference measurement, the UE Rx-Tx time difference measurement, and/or the transmission timing compensation.

In some embodiments, the network node can further estimate a position of the wireless device based at least in part on the estimated RTT.

In some embodiments, the network node receives an estimated accuracy associated with the transmission timing compensation. The network node can estimate a position of the wireless device based at least in part on the estimated RTT and the estimated accuracy associated with the transmission timing compensation.

The various aspects and embodiments described herein can be combined alternatively, optionally and/or in addition to one another.

Other aspects and features of the present disclosure will become apparent to those ordinarily skilled in the art upon review of the following description of specific embodiments in conjunction with the accompanying figures.

### BRIEF DESCRIPTION OF THE DRAWINGS

Embodiments of the present disclosure will now be described, by way of example only, with reference to the attached Figures, wherein:

FIG. 1 illustrates an example of NR positioning architecture;

FIG. 2 illustrates an example of RTT estimation;

FIG. 3 is an example communication system;

FIG. 4 is a flow chart illustrating an example method performed by a wireless device;

FIG. 5 is a flow chart illustrating an example method performed by an access node;

FIG. 6 is a flow chart illustrating an example method performed by a network node;

FIG. 7 illustrates an example of transmission timing compensation estimation;

FIG. 8 is a block diagram of an example wireless device;

FIG. 9 is a block diagram of an example network node;

FIG. 10 is a block diagram of an example host;

FIG. 11 is a block diagram illustrating an example virtualization environment; and

FIG. 12 is a communication diagram of a host communicating via a network node with a UE.

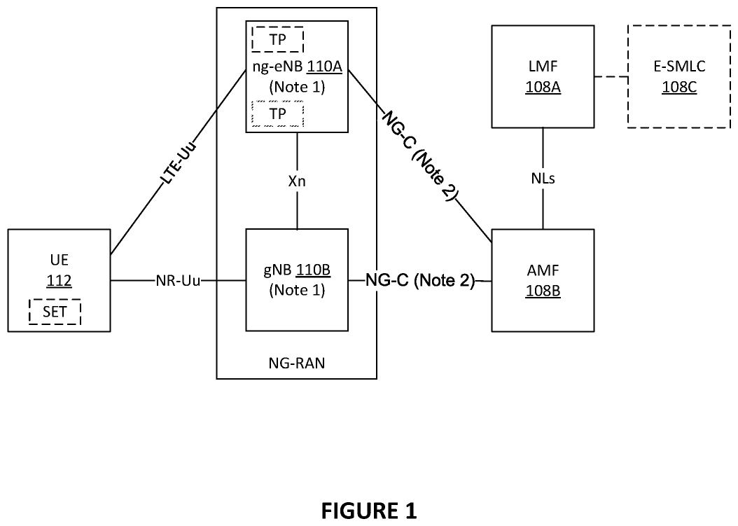

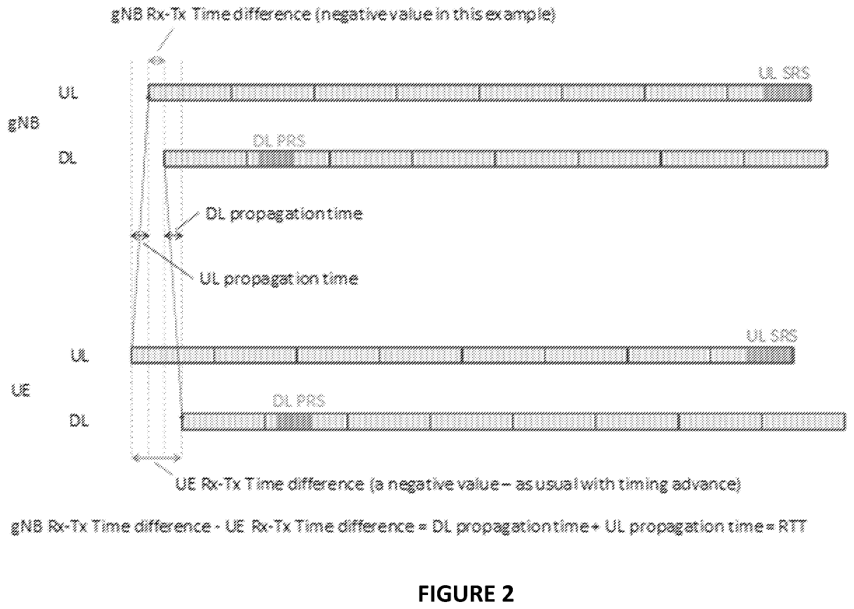

### DETAILED DESCRIPTION

The embodiments set forth below represent information to enable those skilled in the art to practice the embodiments. Upon reading the following description in light of the accompanying drawing figures, those skilled in the art will understand the concepts of the description and will recognize applications of these concepts not particularly addressed herein. It should be understood that these concepts and applications fall within the scope of the description.

In the following description, numerous specific details are set forth. However, it is understood that embodiments may be practiced without these specific details. In other instances, well-known circuits, structures, and techniques have not been shown in detail in order not to obscure the understanding of the description. Those of ordinary skill in the art, with the included description, will be able to implement appropriate functionality without undue experimentation.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to implement such feature, structure, or characteristic in connection with other embodiments whether or not explicitly described.

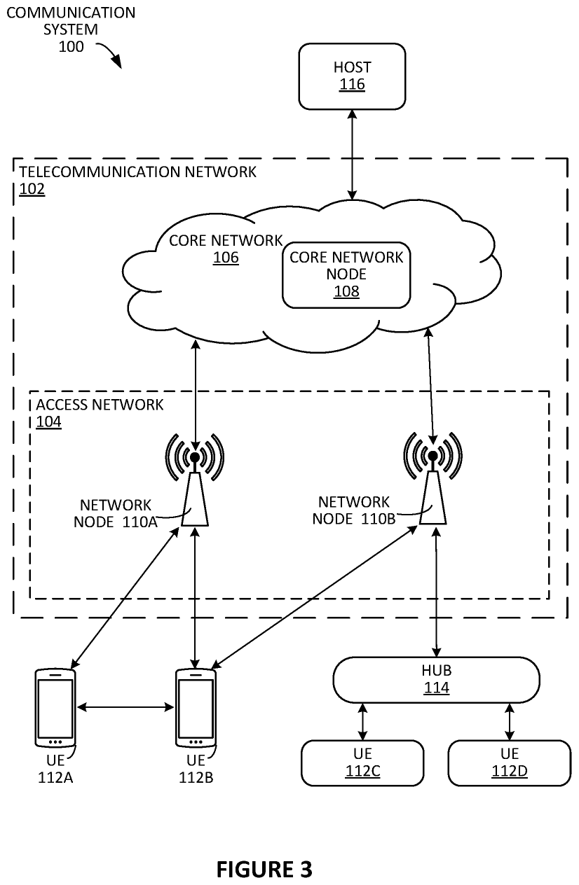

FIG. 3 illustrates an example of a communication system 100 in accordance with some embodiments.

In the example, the communication system 100 includes a telecommunication network 102 that includes an access network 104, such as a radio access network (RAN), and a core network 106, which includes one or more core network nodes 108. The access network 104 includes one or more access network nodes, such as network nodes 110A and 110B (one or more of which may be generally referred to as network nodes 110), or any other similar 3rd Generation Partnership Project (3GPP) access node or non-3GPP access point. The network nodes 110 facilitate direct or indirect connection of user equipment (UE), such as by connecting UEs 112A, 112B, 112C, and 112D (one or more of which may be generally referred to as UEs 112) to the core network 106 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 100 may include any number of wired or wireless networks, network nodes, UEs, and/or any other components or systems that may facilitate or participate in the communication of data and/or signals whether via wired or wireless connections. The communication system 100 may include and/or interface with any type of communication, telecommunication, data, cellular, radio network, and/or other similar type of system.

The UEs 112 may be any of a wide variety of communication devices, including wireless devices arranged, configured, and/or operable to communicate wirelessly with the network nodes 110 and other communication devices. Similarly, the network nodes 110 are arranged, capable, configured, and/or operable to communicate directly or indirectly with the UEs 112 and/or with other network nodes or equipment in the telecommunication network 102 to enable and/or provide network access, such as wireless network access, and/or to perform other functions, such as administration in the telecommunication network 102.

In the depicted example, the core network 106 connects the network nodes 110 to one or more hosts, such as host 116. These connections may be direct or indirect via one or more intermediary networks or devices. In other examples, network nodes may be directly coupled to hosts. The core network 106 includes one or more core network nodes (e.g. core network node 108) that are structured with hardware and software components. Features of these components may be substantially similar to those described with respect to the UEs, network nodes, and/or hosts, such that the descriptions thereof are generally applicable to the corresponding components of the core network node 108. Example core network nodes include functions of one or more of a Mobile Switching Center (MSC), Mobility Management Entity (MME), Home Subscriber Server (HSS), Location Management Function (LMF), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 116 may be under the ownership or control of a service provider other than an operator or provider of the access network 104 and/or the telecommunication network 102, and may be operated by the service provider or on behalf of the service provider. The host 116 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 100 of FIG. 3 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g. 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 102 is a cellular network that implements 3GPP standardized features. Accordingly, the telecommunications network 102 may support network slicing to provide different logical networks to different devices that are connected to the telecommunication network 102. For example, the telecommunications network 102 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 112 are configured to transmit and/or receive information without direct human interaction. For instance, a UE may be designed to transmit information to the access network 104 on a predetermined schedule, when triggered by an internal or external event, or in response to requests from the access network 104. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, the hub 114 communicates with the access network 104 to facilitate indirect communication between one or more UEs (e.g. UE 112C and/or 112D) and network nodes (e.g. network node 110B). In some examples, the hub 114 may be a controller, router, content source and analytics, or any of the other communication devices described herein regarding UEs. For example, the hub 114 may be a broadband router enabling access to the core network 106 for the UEs. As another example, the hub 114 may be a controller that sends commands or instructions to one or more actuators in the UEs. Commands or instructions may be received from the UEs, network nodes 110, or by executable code, script, process, or other instructions in the hub 114. As another example, the hub 114 may be a data collector that acts as temporary storage for UE data and, in some embodiments, may perform analysis or other processing of the data. As another example, the hub 114 may be a content source. For example, for a UE that is a VR headset, display, loudspeaker or other media delivery device, the hub 114 may retrieve VR assets, video, audio, or other media or data related to sensory information via a network node, which the hub 114 then provides to the UE either directly, after performing local processing, and/or after adding additional local content. In still another example, the hub 114 acts as a proxy server or orchestrator for the UEs, in particular in if one or more of the UEs are low energy IoT devices.

The hub 114 may have a constant/persistent or intermittent connection to the network node 110B. The hub 114 may also allow for a different communication scheme and/or schedule between the hub 114 and UEs (e.g. UE 112C and/or 112D), and between the hub 114 and the core network 106. In other examples, the hub 114 is connected to the core network 106 and/or one or more UEs via a wired connection. Moreover, the hub 114 may be configured to connect to an M2M service provider over the access network 104 and/or to another UE over a direct connection. In some scenarios, UEs may establish a wireless connection with the network nodes 110 while still connected via the hub 114 via a wired or wireless connection. In some embodiments, the hub 114 may be a dedicated hub—that is, a hub whose primary function is to route communications to/from the UEs from/to the network node 110B. In other embodiments, the hub 114 may be a non-dedicated hub—that is, a device which is capable of operating to route communications between the UEs and network node 110B, but which is additionally capable of operating as a communication start and/or end point for certain data channels.

Note that the description given herein focuses on a 3GPP cellular communications system and, as such, 3GPP terminology or terminology similar to 3GPP terminology is oftentimes used. However, the concepts disclosed herein are not limited to a 3GPP system.

Note that, in the description herein, reference may be made to the term “cell”. However, particularly with respect to 5G/NR concepts, beams may be used instead of cells and, as such, it is important to note that the concepts described herein are equally applicable to both cells and beams.

Returning to the discussion of timing adjustments, the UE clock drift between the reception of the DL PRS instance used for a UE Rx-Tx time difference measurement and the transmission of an UL SRS used for a gNB Rx-Tx time difference measurement can result in an error in the RTT estimate that is based on the UE Rx-Tx time difference measurement and the gNB Rx-Tx time difference measurement.

UE timing adjustments between the reception of the DL PRS instance used for a UE Rx-Tx time difference measurement and the transmission of an UL SRS used for a gNB Rx-Tx time difference measurement can result in an error in the RTT estimate based on the UE Rx-Tx time difference measurement and the gNB Rx-Tx time difference measurement.

Various proposals have been considered in 3GPP RAN1 discussion. One proposal is to let the UE compensate the reported UE Rx-Tx time difference measurements for transmitting timing differences between the UL subframe closest in time to the subframe for reception of the DL PRS instance used for the UE Rx-Tx time difference measurement and an UL subframe selected by the UE where the UE transmits an UL SRS. Another proposal is to let the UE report timing adjustments to the LMF.

At RAN1 #106bis-e these two proposals were summarized as follows:

Consider supporting one of the following alternatives related to the UE Rx-Tx time difference (decision to be made in RAN1 #106b):

Option 1: Subject to UE capability, the UE may report an additional UL Timestamp associated to a UE Rx-Tx measurement, corresponding to the timing of the uplink subframe of a positioning SRS.

Add the following to the UE Rx-Tx time difference definition (similar to the definition for HD-FDD UE in TS 36.214):

If the UE does not transmit SRS in subframe #j, and if the UE reports an additional timestamp for the positioning SRS associated to the measurement, it shall compensate for the difference in the transmit timing of uplink subframe #j and the transmission timing of the subframe containing positioning SRS.

Option 2: Subject to a UE capability, a UE may optionally report Timing Adjustment (TA) change information

Option 2A: The TA change information is included in the UE Tx TEG report

Option 2B: The TA change information is included in the Rx-Tx measurement report

Note: TA change information corresponds to: Tx Timing change with a timestamp that this change occurred.

Option 3: Send an LS to RAN4, requesting RAN4 to make the decision to select Option 1 or Option 2.

If RAN1 makes the decision to adopt either Option 1 or Option 2, send an LS to RAN4 to check if RAN4 has any issue to support the option.

In the ongoing discussions, one above-described proposal is that the UE may report a timestamp corresponding to an UL subframe in which the UE transmits an UL SRS together with and coupled to a UE Rx-Tx time difference measurement. If the UE does not transmit SRS in subframe #j (as defined in the UE Rx-Tx time difference measurement definition in 3GPP TS 38.215), and if the UE reports an additional timestamp for the positioning SRS associated to the measurement, it shall compensate for the difference in the transmit timing of uplink subframe #j and the transmission timing of the subframe containing positioning SRS.

A disadvantage with the above proposal is that the UE does not know which UL SRS the gNB will use to perform the gNB Rx-Tx time difference measurement that will be used together with a UE Rx-Tx time difference measurement to estimate the RTT. If the UE compensates for the difference in time between the transmit timing of uplink subframe #j and the transmit timing of the subframe containing UL SRS #1, and the gNB on the other hand performs gNB Rx-Tx timing difference measurement based on UL SRS #2, then there will be a mismatch that will result in erroneous RTT estimates.

Another potential issue is that the LMF has no other choice than accepting the compensation performed by the UE independently of whether the LMF considers the compensation useful, useless, or even counterproductive.

Another proposal is for the UE to report timing adjustments to the LMF. A problem with this solution is that it only accounts for timing adjustments and not for clock drifts. Another problem is that UE manufacturers may be opposed to revealing their timing adjustment methods.

Some embodiments described herein include a UE estimating and reporting the transmission timing differences between the DL PRS instance used for a UE-Rx-Tx time difference measurement and a number of UL SRS transmission instances.

In some embodiments, an LMF can estimate the RTT based on a UE Rx-Tx time difference measurement, a gNB Rx-Tx time difference measurement and at least one of the transmission timing compensations reported by the UE and selected by the LMF so that it compensates for the transmission timing difference between the reception of the DL PRS instance used for a UE Rx-Tx time difference measurement and the transmission of the UL SRS used for the gNB Rx-Tx time difference measurement.

In some embodiments, the LMF can utilize the compensated RTT measurements to estimate the position of the UE.

Some embodiments include UE estimation and reporting of the accuracy of reported transmission timing compensation and/or LMF utilization of reported accuracy/quality of transmission timing compensation in estimating RTT and/or UE position.

Some embodiments include the UE reporting which cell the UE has selected as reference cell for transmission timing.

Some embodiments include UE selection of a cell for which a DL PRS has been configured as reference cell.

Some embodiments include the LMF requesting gNB to transmit DL PRS on the cell which the UE has selected as reference cell.

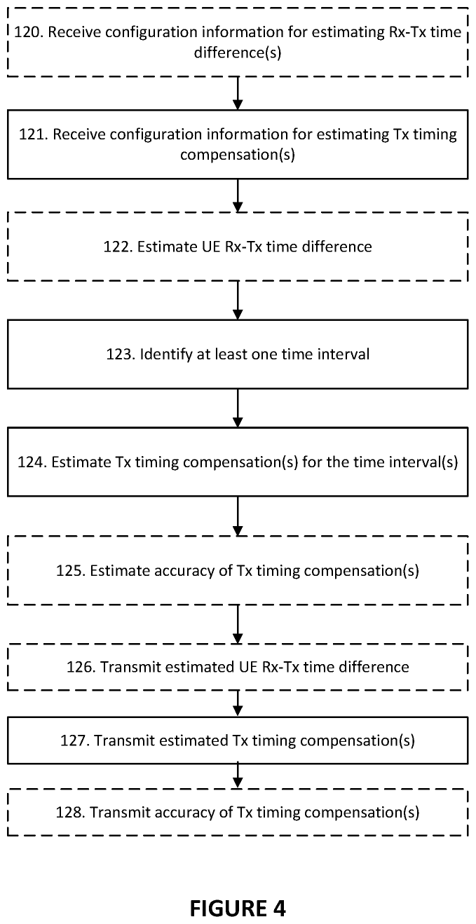

FIG. 4 is a flow chart illustrating an example method for compensating for UE clock drifts and/or UE timing adjustments to improve RTT estimations. The method can be performed in a wireless device, such as a UE 112, as described herein. The method can include:

Step 120: Optionally, the UE is configured (e.g. by the LMF) to estimate and report UE Rx-Tx time differences.

Step 121: The UE is receives configuration information (e.g. from the LMF) to estimate and report transmission timing compensation(s).

Step 122: Optionally, the UE estimates the UE Rx-Tx time differences based on the estimated time of arrival of DL PRSs.

Step 123: The UE determines/identifies the time interval(s) (Iₖ).

Step 124: The UE estimates the transmission timing compensations for the time interval(s) (Iₖ).

Step 125: Optionally, the UE can estimate the accuracy of the transmission timing compensations.

Step 126: Optionally, The UE reports (e.g. transmits to the LMF) the estimated UE Rx-Tx time differences.

Step 127: The UE reports (e.g. transmits to the LMF) the estimated transmission timing compensations.

Step 128: Optionally, the UE reports the accuracy of the transmission timing compensations (e.g. to the LMF).

In some embodiments, the UE does not estimate and report the accuracy of the estimates of the change in transmission timing over the time intervals Iₖ.

It is noted that multiple configurations may be combined in the same configuration message.

It is noted that multiple reporting quantities may be combined and transmitted in the same reporting message.

In some embodiments, the UE identification of time intervals Iₖ amounts to the identification of combinations of DL PRS instances used for a UE Rx-Tx time difference measurement and an SRS instance. The index k then corresponds to one such combination of DL PRS instances used for a UE Rx-Tx time difference measurement and an SRS instance. The time interval Iₖ implicitly or explicitly defined by the combination DL PRS instance and SRS instance, e.g. as the time interval between the DL PRS instance and the UL SRS instance or the interval between the UL subframe closest to the reception of the DL PRS instance and the UL subframe in which the UL SRS instance is transmitted.

In some embodiments the time intervals Iₖ can be explicitly configured by the LMF. In this case, the index k corresponds to different time intervals Iₖ configured by the LMF.

It will be appreciated that in some embodiments, the wireless device (e.g. UE 112) can communicate (e.g. transmit/receive messages) directly with a network node such as location server (e.g. LMF) 108. In other embodiments, messages and signals between the entities may be communicated via other nodes, such as radio access node (e.g. gNB, eNB) 110.

It will be appreciated that one or more of the above steps can be performed simultaneously and/or in a different order. Also, steps illustrated in dashed lines are optional and can be omitted in some embodiments.

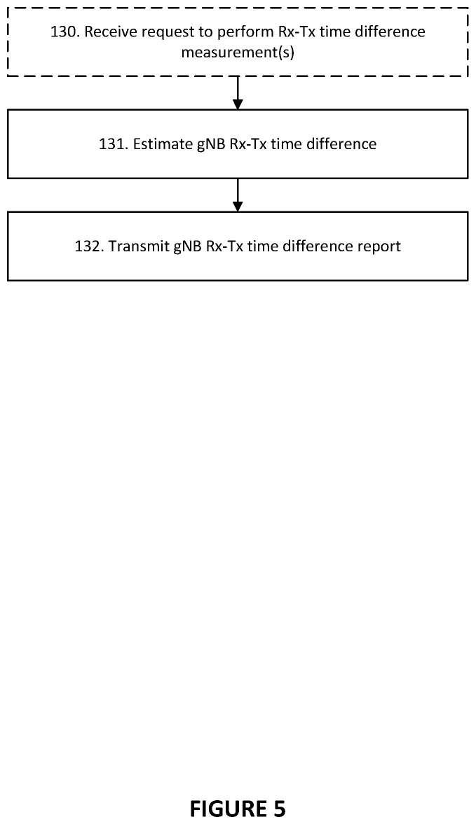

FIG. 5 is a flow chart illustrating an example method for compensating for UE clock drifts and/or UE timing adjustments to improve RTT estimations. The method can be performed in an access node, such as gNB 110 as described herein. The method can include:

Step 130: Optionally, the gNB receives a request (e.g. from the LMF) to perform gNB Rx-Tx time difference measurements. The gNB can further receive configuration information from the LMF for performing gNB Rx-Tx time difference measurements.

Step 131: The gNB estimates the gNB Rx-Tx time difference based on the estimated time of arrival of a UL SRS.

Step 132: The gNB reports the gNB Rx-Tx time difference (e.g. to the LMF).

It will be appreciated that one or more of the above steps can be performed simultaneously and/or in a different order. Also, steps illustrated in dashed lines are optional and can be omitted in some embodiments.

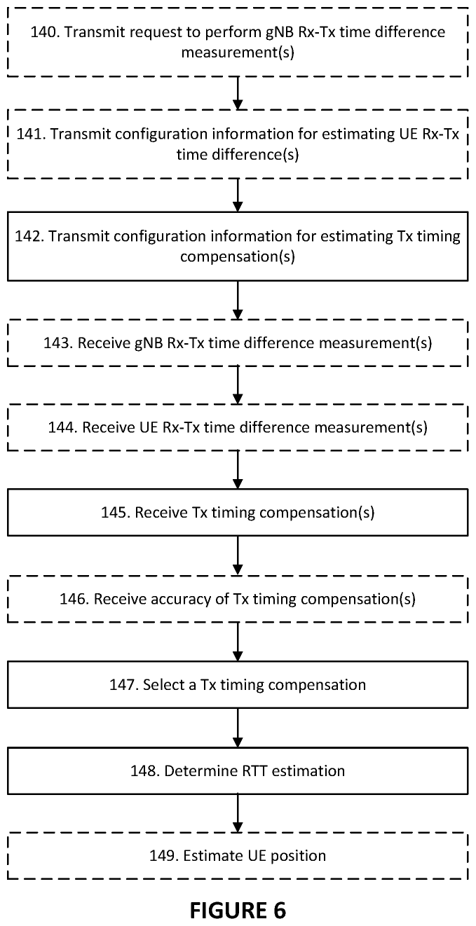

FIG. 6 is a flow chart illustrating an example method for compensating for UE clock drifts and/or UE timing adjustments to improve RTT estimations. The method can be performed in a network node such as core network node 108 (e.g. location server, LMF) as described herein. The method can include:

Step 140: Optionally, the LMF transmits a request to an access node (e.g. gNB) to perform gNB Rx-Tx time difference measurements.

Step 141: Optionally, the LMF configures a UE to estimate and report the UE Rx-Tx time difference.

Step 142: The LMF transmits configuration information the UE to estimate and report transmission timing compensation(s).

Step 143: Optionally, the LMF receives gNB Rx-Tx time difference measurements from one or more access nodes (gNBs).

Step 144: Optionally, the LMF receives UE Rx-Tx time difference measurements from one or more UEs.

Step 145: The LMF receives transmission timing compensation(s) from the UE.

Step 146: Optionally, the LMF further receives an estimate of the accuracy of the transmission timing compensation(s) from the UE.

Step 147: To compensate an RTT estimate based on a gNB Rx-Tx time difference measurement and a UE Rx-Tx time difference measurement, the LMF selects a transmission timing compensation term reported by the UE which compensates for the transmission timing difference between the reception of the DL PRS instance used for a UE Rx-Tx time difference measurement and the transmission of the UL SRS used for the gNB Rx-Tx time difference measurement.

Step 148: The LMF estimates the RTT based at least in part on the gNB Rx-Tx time difference measurement, UE Rx-Tx time difference measurement, and/or the selected transmission timing compensation.

Step 149: Optionally, the LMF estimates the UE position based at least in part on the RTT estimate(s), the estimate(s) of accuracy of the transmission timing compensation, and/or other additional information.

It is noted that multiple configurations can be combined and transmitted in the same configuration message.

It is noted that multiple reporting quantities can be combined and received in the same reporting message.

It will be appreciated that in some embodiments, the wireless device (e.g. UE 112) can communicate (e.g. transmit/receive messages) directly with a network node such as location server (e.g. LMF) 108. In other embodiments, messages and signals between the entities may be communicated via other nodes, such as radio access node (e.g. gNB, eNB) 110.

It will be appreciated that one or more of the above steps can be performed simultaneously and/or in a different order. Also, steps illustrated in dashed lines are optional and can be omitted in some embodiments.

### Identification of Time Interval Iₖ

In some embodiments, the time interval Iₖ can be implicitly or explicitly related to reception of the DL PRS instance used for the UE Rx-Tx time difference measurement and the transmission of an instance of an UL SRS resource potentially used for a gNB Rx-Tx time difference measurement. Each combination of DL PRS instance and UL SRS instance can give a time interval Iₖ.

In some embodiments, for a given UL SRS resource (e.g. as configured by the LMF), the UE selects the instance of that UL SRS resource which is closest in time to the reception of the DL PRS instance used for the UE Rx-Tx time difference measurement.

In one embodiment, the time interval Iₖ is defined as the time interval between the UL subframe #j closest to the reception of the DL PRS used for the UE Rx-Tx time difference measurement and the UL subframe #k in which the UL SRS resource instance is transmitted.

In one embodiment, the time interval Iₖ is defined as the time interval between the reception of the DL PRS used for the UE Rx-Tx time difference measurement and the transmission of the UL SRS resource.

In one embodiment, the time intervals Iₖ can be explicitly configured by the LMF. The LMF can select the time intervals Iₖ in several ways. In one variant of this embodiment, the LMF selects one end point of the interval Iₖ as the UL subframe #j closest to the reception of the DL PRS instance expected to be used by the UE for a UE Rx-Tx time difference measurement and selects the other end point of the interval Iₖ as the UL subframe #k where the UE is configured to transmit an instance of an UL SRS expected to be used by a gNB for a gNB Rx-Tx time difference measurement. In another variant of this embodiment, the LMF selects one end point of the interval Iₖ as the UL slot #j closest to the reception of the DL PRS instance expected to be used by the UE for a UE Rx-Tx time difference measurement and selects the other end point of the interval Iₖ as the UL slot #k where the UE is configured to transmit an instance of an UL SRS expected to be used by a gNB for a gNB Rx-Tx time difference measurement.

In some embodiments, the time interval can be implicitly configured by the LMF by indication of what UL SRS resources should be used by the UE to identify the time interval to use.

In one embodiment, the time interval is implicitly configured by the LMF by configuring the UE with a list of UL SRS resources for each target TRP. The UE identifies (based on, for example, one of the methods described above) one time interval Iₖ for each combination of listed UL SRS resource and DL PRS used for UE Rx-Tx time difference estimation towards the target TRP.

In one embodiment, the time interval is implicitly configured by the LMF by configuring the UE with a list of UL SRS resources for each DL PRS. The UE identifies (based on, for example, one of the methods described above) one time interval Iₖ for each combination of listed UL SRS resource and DL PRS.

### Transmission Timing Compensation Reporting

In some embodiments, the transmission timing compensation can be reported with one timestamp for the start of the time interval Iₖ, and another timestamp for the end of the time interval Iₖ. In one such embodiment, the timestamps can be signaled in terms of a UL subframe. In another embodiment, the timestamps can be signaled in terms of a UL slot.

In some embodiments, where the time intervals Iₖ are configured explicitly by the LMF together with an interval ID, the UE can report the transmission timing compensation together with the corresponding interval ID.

In some embodiments, the transmission timing compensation can be reported as part of the Multi-RTT measurement report in LPP.

In one embodiment, the transmission timing compensation is not tied to any specific UE Rx-Tx time difference measurement in the multi-RTT measurement report. Note that this can avoid sending duplicate transmission timing compensations for the same time interval Iₖ coupled to different UE Rx-Tx time difference measurements. For instance, consider the case where there are two DL PRS resources in a slot (typically transmitted from two different TRPs), and the UE performs two different UE Rx-Tx time difference measurements using the two DL PRS resources. It is further assumed that the UE wants to perform transmission timing compensation using the same UL SRS resource. Assuming that the time interval Iₖ is defined as the UL subframe #j closest to the reception of the DL PRS used for the UE Rx-Tx time difference measurement and the UL subframe #k in which the UL SRS resource is transmitted, the time interval Iₖ coupled to the two different UE Rx-Tx time difference measurements are the same (note that given that the 2 DL PRS resources are in the same slot, the closest UL subframe #j is the same in the cases of the 2 DL PRS resources). In this embodiment, it is sufficient that the UE reports the transmission timing compensation in the interval Iₖ even though the UE reports two different UE Rx-Tx time difference measurements. This can save reporting overhead over the case where the UE would report the transmission timing compensation separately for each UE Rx-Tx time difference measurement.

In another embodiment:
the transmission timing compensation is associated with a specific UE Rx-Tx time difference measurement in the multi-RTT measurement report;
the transmission timing compensation is reported together with an UL SRS resource indication, but without any timestamp other than the one reported for the UE Rx-Tx time difference;
the transmission timing compensation can be viewed as the compensation term for an RTT based on the UE Rx-Tx time difference and a gNB Rx-Tx time difference based on the indicated UL SRS.

Note that this embodiment may result in the UE reporting duplicate compensation terms, by reporting the compensation term for the same time interval but associated with different DL PRSs or UL SRSs. This embodiment could, however, allow the for the UE to compensate for additional errors (e.g. on top of timing adjustments and clock drifts) that differ between the different UE Rx-Tx time difference measurements such as, for example, differences in receive or transmit timing errors that could differ (e.g. depending on what antenna panel that was used for the RX of the DL PRS and TX of the UL SRS).

### Transmission Timing Compensation Estimation

In some embodiment, the transmission timing compensation for the time interval I_k is defined as the difference in transmission timing between the end of the time interval and the start of the time interval.

In some embodiments, the UE estimate of the transmission timing compensation in the time interval I_k is the UE's estimate of the difference in transmission timing between the end of the time interval I_k and the start of the time interval I_k.

It is noted that the transmission timing compensation for the time interval I_k can also be viewed as a transmission timing compensation term for the RTT estimate calculated based on a UE Rx-Tx time difference based on a certain DL PRS and a gNB Rx-Tx time difference based on a certain UL SRS, where the time interval I_k is based on the same DL PRS and UL SRS.

In some embodiments, the UE estimates the difference in transmission timing between the end of the time interval and the start of the time interval based on:
transmission timing adjustments made within the time interval; and/or
transmission timing estimates made within the time interval.

A detailed example embodiment of transmission timing compensation estimation is as follows. To estimate the difference in transmission timing between the end of the time interval interval Iₖ and the start of the time interval interval Iₖ the UE performs the following steps.

If two reference signals from the reference cell suitable for TOA estimation (e.g. TRS, DL PRS or SSB) can't be found within the time interval Iₖ=(t_{A}, t_{E}), then calculate the transmission timing compensation as the sum of all transmission timing adjustments performed within the interval Iₖ. Also estimate the accuracy of the transmission timing compensation as

$$max clockdrift ( {t}_{A} , {t}_{E} ) + w$$

where maxclockdrift(t_{A}, t_{E}) is the maximum UE clock drift over the time interval (t_{A}, t_{E}) as estimated by the UE and the constant w represents error contributions from e.g. TOA estimates and inaccuracies in UE knowledge of applied timing adjustments.

### Otherwise:

Identify two reference signals from the reference cell suitable for TOA estimation (e.g. TRS, DL PRS or SSB) within the time interval Iₖ=(t_{A}, t_{E}). The reference signals are selected to make the time interval between the two reference signals as large as possible while still allowing for sufficiently accurate TOA estimates. The interval between the two selected reference signals will be referred to as I′=(t_{B}, t_{C}).

Estimate the transmission timing offset at the time instances of the reception of the two selected reference signals, i.e. at t_{B} and t_{C} based on TOA estimation.

Calculate the transmission timing difference over the time interval I′, i.e between t_{C} and t_{B}.

Calculate the transmission timing compensation as the sum of the transmission timing difference over the time interval I′ and all transmission timing adjustments performed within the interval Iₖ but not within the interval I′ (or equivalently all transmission timing adjustments performed within the intervals (t_{A}, t_{B}) or (t_{C}, t_{E}).

Estimate of the accuracy of the transmission timing compensation as

$$max clockdrift ( {t}_{A} , {t}_{B} ) + max clockdrift ( {t}_{C} , {t}_{E} ) + w$$

where maxclockdrift(t₁, t₂) is the maximum UE clock drift over the time interval (t₁, t₂) as estimated by the UE and the constant w represents error contributions from e.g. TOA estimates and inaccuracies in UE knowledge of applied timing adjustments.

The maximum clock drift over a time interval (t₁, t₂) could be estimated, e.g. as

$$max clockdrift ( {t}_{1} , {t}_{2} ) = ( {( Δ f )}_{0} + k \cdot ( {t}_{1} - {t}_{0} ) ) \cdot ( {t}_{2} - {t}_{1} ) + \frac{k}{2} \cdot ( {t}_{2}^{2} - {t}_{1}^{2} )$$

where t₀ is most recent time before the time interval (t₁, t₂) the UE performed a frequency synch towards a received signal (e.g. a TRS) from the reference cell, (Δf)₀ is the maximum frequency offset of the UE oscillator frequency relative to the received DL frequency from the reference cell directly after that frequency synch (i.e. the accuracy of the frequency synch), and k is the maximum frequency drift per time.

The logic behind this formula is that the clock drift over a time interval is the integral of the frequency offset of the clock-oscillator over that time interval and the maximum frequency offset can be written as

$$Δ f ( t ) = {( Δ f )}_{0} + k \cdot ( t - {t}_{0} )$$

$$and$$

$$max clockdrift ( {t}_{1} , {t}_{2} ) = {\int }_{{t}_{1}}^{{t}_{2}} Δ f ( t ) \cdot dt = ( {( Δ f )}_{0} + k \cdot ( {t}_{1} - {t}_{0} ) ) \cdot ( {t}_{2} - {t}_{1} ) + \frac{k}{2} \cdot ( {t}_{2}^{2} - {t}_{1}^{2} )$$

The UE could alternatively use other ways to estimate the maximum clock drift, e.g. taking into account knowledge about UE states (e.g. turning on or off UE transmission) impacting temperature and frequency/time drifts.

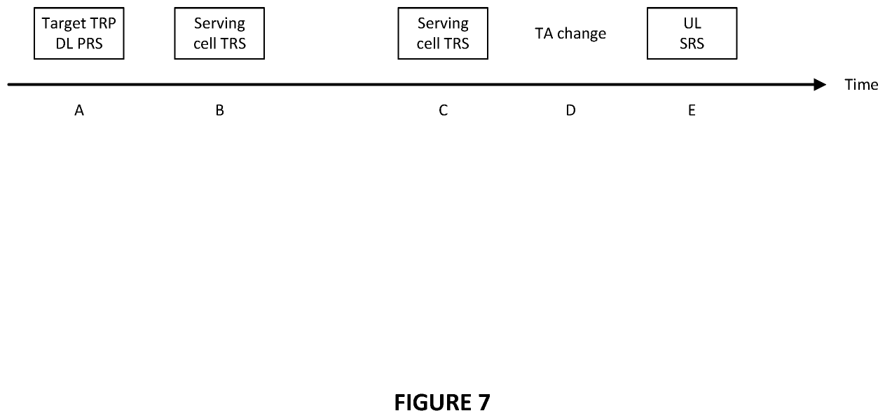

FIG. 7 is an illustration of example events impacting a UE Rx-Tx time difference measurement and timing difference compensation.

In a first example, following events occur:

A. The UE receives the DL PRS from the target TRP at time instance A, measures the TOA and use that to calculate the UE Rx-Tx time difference.

B. The UE receives the TRS from the serving cell at time instance B and measures the TOA.
Based on the TOA the UE calculates the transmission timing offset T_{offset}(B). The UE decides not to perform a timing adjustment since the timing offset T_{offset}(B) is close enough to the stipulated offset (N_{TA}+N_{TA offset})×T_{c}.

C. The UE receives the TRS from the serving cell at time instance C and measures the TOA.
Based on the TOA the UE calculates the transmission timing offset T_{offset}(C). The UE decides to perform a timing adjustment since the timing offset T_{offset}(C) is too far from the stipulated offset (N_{TA}+N_{TA offset})×T_{c}.

D. The UE performs a timing adjustment of size T_{TA}(D).
The natural value for the timing adjustment is T_{TA}(D)=(N_{TA}+N_{TA offset})×T_{c}−T_{offset}(C) bringing the transmission timing offset back to the stipulated value but the UE may also perform a smaller adjustment.

E. The UE transmits the UL SRS with transmission timing offset T_{offset}(E)

The timing offset difference between time instance A and E can be written as:

$${T}_{offset} ( E ) - {T}_{offset} ( A ) = {T}_{drift} ( A , B ) + {T}_{drift} ( B , C ) + {T}_{drift} ( C , E ) + {T}_{TA} ( D )$$

It is noted that the transmission timing adjustment T_{TA}(D) is performed and known to the UE and the T_{drift}(B, C)=T_{offset}(C)−T_{offset}(B) can be estimated by the UE since T_{offset}(B) and T_{offset}(C) can be estimated based on time of arrival measurements based on the TRS received at time instances B and C respectively. Thus, it can be written:

$${T}_{offset} ( E ) - {T}_{offset} ( A ) = {T}_{drift} ( A , B ) + {T}_{drift} ( C , E ) + {T}_{COMP}$$

$$where$$

$${T}_{COMP} = {T}_{drift} ( B , C ) + {T}_{TA} ( D )$$

is estimated by the UE and can be reported to the LMF as transmission timing compensation.

However, the reported transmission timing compensation T_{COMP} is not equal to the timing offset difference between time instances A and E, but deviates with

$${T}_{offset} ( E ) - {T}_{offset} ( A ) - {T}_{COMP} = {T}_{drift} ( A , B ) + {T}_{drift} ( C , E )$$

If the time intervals (A, B) and (C, E) are short the transmission timing drift (which is typically due to UE clock drift) is small. Since the transmission timing adjustment T_{TA}(D) can be large, knowledge of T_{COMP} can give a significant improvement in RTT accuracy and thus also of positioning accuracy.

The UE can also estimate the size of the deviation T_{drift}(A, B)+T_{drift}(C, E) based on UE knowledge about the maximum UE clock drift per time, e.g. as k·(t_{B}−t_{A}+t_{E}−t_{C}) where k is the maximum UE clock drift per time. This value can be reported to the LMF as an estimate of the accuracy of the transmission timing compensation. The estimate of the accuracy of the transmission timing compensation can also include contributions from errors in the time of arrival estimations used by the UE to calculate T_{COMP} and inaccuracies in the UE knowledge about the size of the applied timing adjustments T_{TA}(D).

In the language of “intervals” used herein, Iₖ=(t_{A}, t_{B}) and I′=(t_{B}, t_{C}).

### Configuration of UE to Report Transmission Timing Compensation

In some embodiments, the LMF can configure a UE with a list of SRS resources for each TRP for reporting of transmission timing compensation. When the UE reports a UE Rx-Tx time difference measurement for that TRP, the UE can also report transmission timing compensation for that UE Rx-Tx time difference measurement for each of the listed SRS resources.

In some embodiments, the LMF can configure a UE with a list of SRS resource sets and SRS resources for each TRP for reporting of transmission timing compensation. In such case that an SRS resource set is listed, that should be interpreted as including all SRS resources in the SRS resource set in the list of SRS resources. When the UE reports a UE Rx-Tx time difference measurement for a given TRP, the UE can also report transmission timing compensation for that UE Rx-Tx time difference measurement for each of the listed SRS resources.

In one embodiment, the LMF configures a UE with a list of SRS resources for each DL PRS for reporting of transmission timing compensation. When the UE reports a UE Rx-Tx time difference measurement based on that DL PRS, the UE can also report transmission timing compensation for that UE Rx-Tx time difference measurement for each of the listed SRS resources.

In one embodiment, the LMF configures a UE with a list of SRS resource sets and SRS resources for each DL PRS for reporting of transmission timing compensation. In such case that a SRS resource set is listed, that should be interpreted as including all SRS resources in the SRS resource set in the list of SRS resources. When the UE reports a UE Rx-Tx time difference measurement based on a given DL PRS, the UE can also report transmission timing compensation for that UE Rx-Tx time difference measurement for each of the listed SRS resources.

### Utilization of Reported Accuracy of Transmission Timing Compensation

In one embodiment, the LMF estimates the RTT measurement without compensating for transmission timing if the reported accuracy/quality of the transmission timing compensation is below a threshold.

In one embodiment, in estimating the position of a UE, the LMF discards RTT measurements that are impacted by timing transmission timing compensation if the reported accuracy/quality of the transmission timing compensation is below a threshold.

In one embodiment, in estimating the position of a UE the LMF by minimizing a cost function, the LMF weights the RTT measurement impact on the cost function based on the reported accuracy/quality of the transmission timing compensation.

In one embodiment, the LMF makes two RTT estimates, one with transmission timing compensation and one without transmission timing compensation. The LMF next uses an outlier rejection method such as RANSAC to reject one of the RTT estimates when estimating the position of the UE.

In one embodiment, for RTT estimation, the LMF selects one of several reported gNB Rx-Tx time difference measurement based on the criteria that the corresponding transmission timing compensation should have a good quality indication.

### Reference Cell Selection and Reporting

Transmission timing is defined relative to the reference cell as described in 3GPP TS 38.133 v3.7.0. UE transmit timing and timing adjustments are described in section 7.1:

The UE shall have capability to follow the frame timing change of the reference cell in connected state. The uplink frame transmission takes place (N_{TA}+N_{TA offset})×T_{c} before the reception of the first detected path (in time) of the corresponding downlink frame from the reference cell. For serving cell(s) in pTAG, UE shall use the SpCell as the reference cell for deriving the UE transmit timing for cells in the pTAG. For serving cell(s) in sTAG, UE shall use any of the activated SCells as the reference cell for deriving the UE transmit timing for the cells in the sTAG. UE initial transmit timing accuracy and gradual timing adjustment requirements are defined in the following requirements.

Since the timing may differ between different cells, it can be beneficial if a DL PRS is transmitted over the cell selected by the UE as reference cell.

In one embodiment, the UE reports to the LMF which cell the UE has selected as reference cell for transmission timing.

In one embodiment, the UE reports to the gNB which cell the UE has selected as reference cell for transmission timing, and the gNB forwards this information to the LMF.

In one embodiment, the gNB utilizes this information to request the gNB to transmit a DL PRS on the cell selected by the UE as reference cell.

In one embodiment, the UE selects a cell for which a DL PRS has been configured as reference cell.

Some of the embodiments described herein provide for UE reporting of transmission timing compensation for RTT estimation and/or LMF selection of the transmission timing compensation reported by the UE to use for RTT estimation.

Some of the embodiments described herein provide for LMF estimation of RTT based on UE Rx-Tx time difference measurement, gNB Rx-Tx time difference measurement and transmission timing compensation. The LMF estimation of UE position can be based on RTT estimates compensated for transmission timing differences.

Some of the embodiments described herein provide for configuration of a UE by the LMF to perform and report transmission timing compensation. The UE can determine an estimation of transmission timing compensation and/or an estimation of transmission timing differences.

Some embodiments allow for improved accuracy in RTT estimates based on compensation for transmission timing differences due to clock drifts and UE timing adjustments.

Some embodiments allow for improved accuracy in UE position estimates based on compensation for transmission timing differences due to clock drifts and UE timing adjustments.

Transmission timing compensation can be also possible when the UE(s) are transmitting multiple SRSs without risking compensating for the wrong SRS.

Some embodiments can help in avoiding overhead due to reporting of duplicate transmission timing compensations.

Some embodiments can provide improved accuracy in UE position estimates based on reported accuracy/quality of transmission timing compensation.

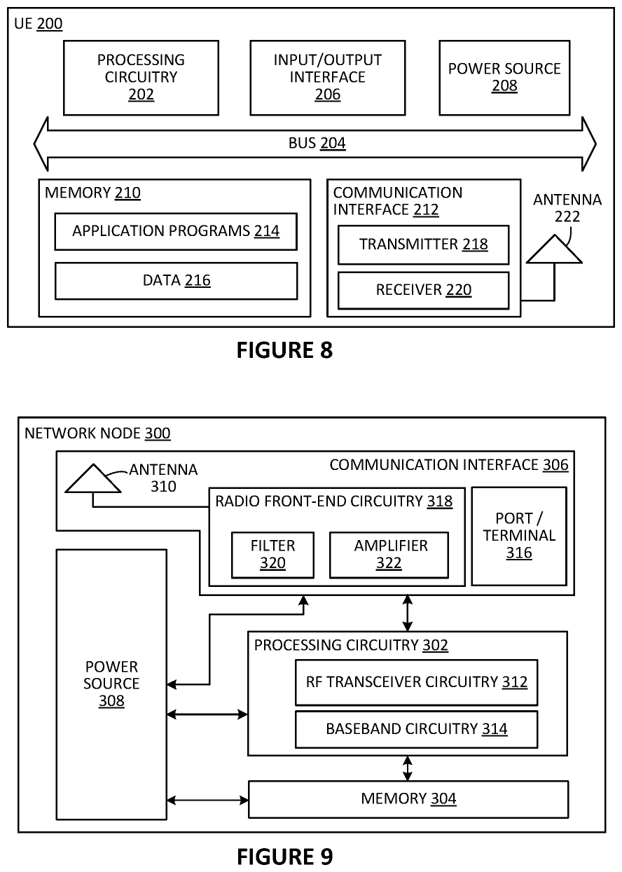

FIG. 8 shows a UE 200, which may be an embodiment of the UE 112 of FIG. 3 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VoIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 200 includes processing circuitry 202 that is operatively coupled via a bus 204 to an input/output interface 206, a power source 208, a memory 210, a communication interface 212, and/or any other component, or any combination thereof. Certain UEs may utilize all or a subset of the components shown in FIG. 8. The level of integration between the components may vary from one UE to another UE. Further, certain UEs may contain multiple instances of a component, such as multiple processors, memories, transceivers, transmitters, receivers, etc.

The processing circuitry 202 is configured to process instructions and data and may be configured to implement any sequential state machine operative to execute instructions stored as machine-readable computer programs in the memory 210. The processing circuitry 202 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 202 may include multiple central processing units (CPUs).

In the example, the input/output interface 206 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 200. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 208 is structured as a battery or battery pack. Other types of power sources, such as an external power source (e.g., an electricity outlet), photovoltaic device, or power cell, may be used. The power source 208 may further include power circuitry for delivering power from the power source 208 itself, and/or an external power source, to the various parts of the UE 200 via input circuitry or an interface such as an electrical power cable. Delivering power may be, for example, for charging of the power source 208. Power circuitry may perform any formatting, converting, or other modification to the power from the power source 208 to make the power suitable for the respective components of the UE 200 to which power is supplied.

The memory 210 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 210 includes one or more application programs 214, such as an operating system, web browser application, a widget, gadget engine, or other application, and corresponding data 216. The memory 210 may store, for use by the UE 200, any of a variety of various operating systems or combinations of operating systems.

The memory 210 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 210 may allow the UE 200 to access instructions, application programs and the like, stored on transitory or non-transitory memory media, to off-load data, or to upload data. An article of manufacture, such as one utilizing a communication system may be tangibly embodied as or in the memory 210, which may be or comprise a device-readable storage medium.

The processing circuitry 202 may be configured to communicate with an access network or other network using the communication interface 212. The communication interface 212 may comprise one or more communication subsystems and may include or be communicatively coupled to an antenna 222. The communication interface 212 may include one or more transceivers used to communicate, such as by communicating with one or more remote transceivers of another device capable of wireless communication (e.g., another UE or a network node in an access network). Each transceiver may include a transmitter 218 and/or a receiver 220 appropriate to provide network communications (e.g., optical, electrical, frequency allocations, and so forth). Moreover, the transmitter 218 and receiver 220 may be coupled to one or more antennas (e.g., antenna 222) and may share circuit components, software or firmware, or alternatively be implemented separately.

In the illustrated embodiment, communication functions of the communication interface 212 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 212, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 200 shown in FIG. 8.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 9 shows a network node 300, which may be an embodiment of the access node 110 or the core network node 108 of FIG. 3, in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 300 includes a processing circuitry 302, a memory 304, a communication interface 306, and a power source 308. The network node 300 may be composed of multiple physically separate components (e.g., a NodeB component and a RNC component, or a BTS component and a BSC component, etc.), which may each have their own respective components. In certain scenarios in which the network node 300 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 300 may be configured to support multiple radio access technologies (RATs). In such embodiments, some components may be duplicated (e.g., separate memory 304 for different RATs) and some components may be reused (e.g., a same antenna 310 may be shared by different RATs). The network node 300 may also include multiple sets of the various illustrated components for different wireless technologies integrated into network node 300, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 300.

The processing circuitry 302 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 300 components, such as the memory 304, to provide network node 300 functionality.

In some embodiments, the processing circuitry 302 includes a system on a chip (SOC). In some embodiments, the processing circuitry 302 includes one or more of radio frequency (RF) transceiver circuitry 312 and baseband processing circuitry 314. In some embodiments, the radio frequency (RF) transceiver circuitry 312 and the baseband processing circuitry 314 may be on separate chips (or sets of chips), boards, or units, such as radio units and digital units. In alternative embodiments, part or all of RF transceiver circuitry 312 and baseband processing circuitry 314 may be on the same chip or set of chips, boards, or units.

The memory 304 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 302. The memory 304 may store any suitable instructions, data, or information, including a computer program, software, an application including one or more of logic, rules, code, tables, and/or other instructions capable of being executed by the processing circuitry 302 and utilized by the network node 300. The memory 304 may be used to store any calculations made by the processing circuitry 302 and/or any data received via the communication interface 306. In some embodiments, the processing circuitry 302 and memory 304 is integrated.

The communication interface 306 is used in wired or wireless communication of signaling and/or data between a network node, access network, and/or UE. As illustrated, the communication interface 306 comprises port(s)/terminal(s) 316 to send and receive data, for example to and from a network over a wired connection. The communication interface 306 also includes radio front-end circuitry 318 that may be coupled to, or in certain embodiments a part of, the antenna 310. Radio front-end circuitry 318 comprises filters 320 and amplifiers 322. The radio front-end circuitry 318 may be connected to an antenna 310 and processing circuitry 302. The radio front-end circuitry may be configured to condition signals communicated between antenna 310 and processing circuitry 302. The radio front-end circuitry 318 may receive digital data that is to be sent out to other network nodes or UEs via a wireless connection. The radio front-end circuitry 318 may convert the digital data into a radio signal having the appropriate channel and bandwidth parameters using a combination of filters 320 and/or amplifiers 322. The radio signal may then be transmitted via the antenna 310. Similarly, when receiving data, the antenna 310 may collect radio signals which are then converted into digital data by the radio front-end circuitry 318. The digital data may be passed to the processing circuitry 302. In other embodiments, the communication interface may comprise different components and/or different combinations of components.

In certain alternative embodiments, the network node 300 does not include separate radio front-end circuitry 318, instead, the processing circuitry 302 includes radio front-end circuitry and is connected to the antenna 310. Similarly, in some embodiments, all or some of the RF transceiver circuitry 312 is part of the communication interface 306. In still other embodiments, the communication interface 306 includes one or more ports or terminals 316, the radio front-end circuitry 318, and the RF transceiver circuitry 312, as part of a radio unit (not shown), and the communication interface 306 communicates with the baseband processing circuitry 314, which is part of a digital unit (not shown).

The antenna 310 may include one or more antennas, or antenna arrays, configured to send and/or receive wireless signals. The antenna 310 may be coupled to the radio front-end circuitry 318 and may be any type of antenna capable of transmitting and receiving data and/or signals wirelessly. In certain embodiments, the antenna 310 is separate from the network node 300 and connectable to the network node 300 through an interface or port.

The antenna 310, communication interface 306, and/or the processing circuitry 302 may be configured to perform any receiving operations and/or certain obtaining operations described herein as being performed by the network node. Any information, data and/or signals may be received from a UE, another network node and/or any other network equipment. Similarly, the antenna 310, the communication interface 306, and/or the processing circuitry 302 may be configured to perform any transmitting operations described herein as being performed by the network node. Any information, data and/or signals may be transmitted to a UE, another network node and/or any other network equipment.

The power source 308 provides power to the various components of network node 300 in a form suitable for the respective components (e.g., at a voltage and current level needed for each respective component). The power source 308 may further comprise, or be coupled to, power management circuitry to supply the components of the network node 300 with power for performing the functionality described herein. For example, the network node 300 may be connectable to an external power source (e.g., the power grid, an electricity outlet) via an input circuitry or interface such as an electrical cable, whereby the external power source supplies power to power circuitry of the power source 308. As a further example, the power source 308 may comprise a source of power in the form of a battery or battery pack which is connected to, or integrated in, power circuitry. The battery may provide backup power should the external power source fail.

Embodiments of the network node 300 may include additional components beyond those shown in FIG. 9 for providing certain aspects of the network node's functionality, including any of the functionality described herein and/or any functionality necessary to support the subject matter described herein. For example, the network node 300 may include user interface equipment to allow input of information into the network node 300 and to allow output of information from the network node 300. This may allow a user to perform diagnostic, maintenance, repair, and other administrative functions for the network node 300.

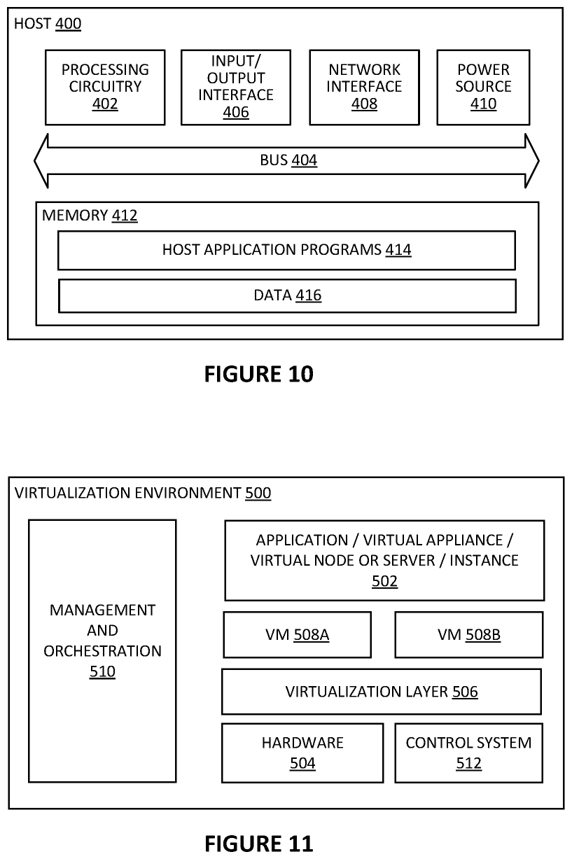

FIG. 10 is a block diagram of a host 400, which may be an embodiment of the host 116 of FIG. 3, in accordance with various aspects described herein. As used herein, the host 400 may be or comprise various combinations hardware and/or software, including a standalone server, a blade server, a cloud-implemented server, a distributed server, a virtual machine, container, or processing resources in a server farm. The host 400 may provide one or more services to one or more UEs.

The host 400 includes processing circuitry 402 that is operatively coupled via a bus 404 to an input/output interface 406, a network interface 408, a power source 410, and a memory 412. Other components may be included in other embodiments. Features of these components may be substantially similar to those described with respect to the devices of previous figures, such as FIGS. 8 and 9, such that the descriptions thereof are generally applicable to the corresponding components of host 400.

The memory 412 may include one or more computer programs including one or more host application programs 414 and data 416, which may include user data, e.g., data generated by a UE for the host 400 or data generated by the host 400 for a UE. Embodiments of the host 400 may utilize only a subset or all of the components shown. The host application programs 414 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 414 may also provide for user authentication and licensing checks and may periodically report health, routes, and content availability to a central node, such as a device in or on the edge of a core network. Accordingly, the host 400 may select and/or indicate a different host for over-the-top services for a UE. The host application programs 414 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. 11 is a block diagram illustrating a virtualization environment 500 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 500 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 502 (which may alternatively be called software instances, virtual appliances, network functions, virtual nodes, virtual network functions, etc.) are run in the virtualization environment 500 to implement some of the features, functions, and/or benefits of some of the embodiments disclosed herein.

Hardware 504 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 506 (also referred to as hypervisors or virtual machine monitors (VMMs)), provide VMs 508a and 508b (one or more of which may be generally referred to as VMs 508), and/or perform any of the functions, features and/or benefits described in relation with some embodiments described herein. The virtualization layer 506 may present a virtual operating platform that appears like networking hardware to the VMs 508.

The VMs 508 comprise virtual processing, virtual memory, virtual networking or interface and virtual storage, and may be run by a corresponding virtualization layer 506. Different embodiments of the instance of a virtual appliance 502 may be implemented on one or more of VMs 508, and the implementations may be made in different ways. Virtualization of the hardware is in some contexts referred to as network function virtualization (NFV). NFV may be used to consolidate many network equipment types onto industry standard high-volume server hardware, physical switches, and physical storage, which can be located in data centers, and customer premise equipment.

In the context of NFV, a VM 508 may be a software implementation of a physical machine that runs programs as if they were executing on a physical, non-virtualized machine. Each of the VMs 508, and that part of hardware 504 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 508 on top of the hardware 504 and corresponds to the application 502.

Hardware 504 may be implemented in a standalone network node with generic or specific components. Hardware 504 may implement some functions via virtualization. Alternatively, hardware 504 may be part of a larger cluster of hardware (e.g. such as in a data center or CPE) where many hardware nodes work together and are managed via management and orchestration 510, which, among others, oversees lifecycle management of applications 502. In some embodiments, hardware 504 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 512 which may alternatively be used for communication between hardware nodes and radio units.

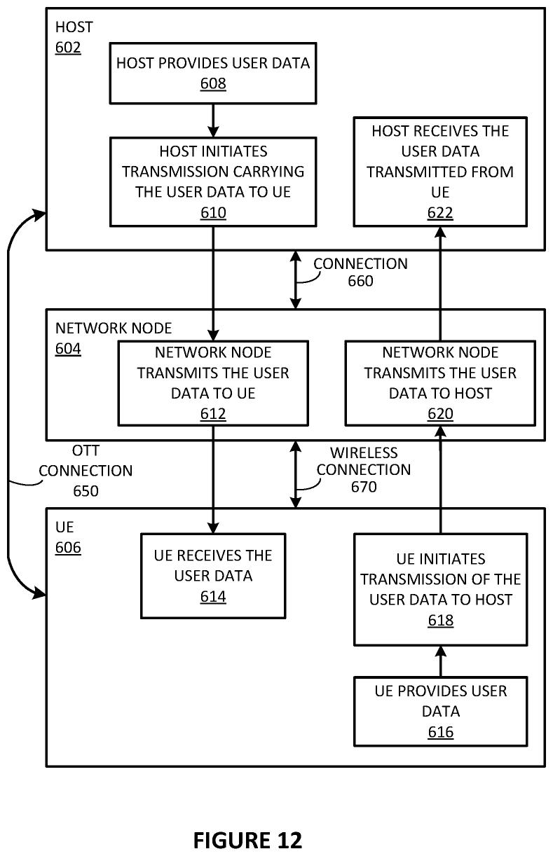

FIG. 12 shows a communication diagram of a host 602 communicating via a network node 604 with a UE 606 over a partially wireless connection in accordance with some embodiments. Example implementations, in accordance with various embodiments, of the UE (such as a UE 112A of FIG. 3 and/or UE 200 of FIG. 8), network node (such as network node 110A of FIG. 3 and/or network node 300 of FIG. 9), and host (such as host 116 of FIG. 3 and/or host 400 of FIG. 10) discussed in the preceding paragraphs will now be described with reference to FIG. 12.

Like host 400, embodiments of host 602 include hardware, such as a communication interface, processing circuitry, and memory. The host 602 also includes software, which is stored in or accessible by the host 602 and executable by the processing circuitry. The software includes a host application that may be operable to provide a service to a remote user, such as the UE 606 connecting via an over-the-top (OTT) connection 650 extending between the UE 606 and host 602. In providing the service to the remote user, a host application may provide user data which is transmitted using the OTT connection 650.

The network node 604 includes hardware enabling it to communicate with the host 602 and UE 606. The connection 660 may be direct or pass through a core network (like core network 106 of FIG. 4) and/or one or more other intermediate networks, such as one or more public, private, or hosted networks. For example, an intermediate network may be a backbone network or the Internet.

The UE 606 includes hardware and software, which is stored in or accessible by UE 606 and executable by the UE's processing circuitry. The software includes a client application, such as a web browser or operator-specific “app” that may be operable to provide a service to a human or non-human user via UE 606 with the support of the host 602. In the host 602, an executing host application may communicate with the executing client application via the OTT connection 650 terminating at the UE 606 and host 602. In providing the service to the user, the UE's client application may receive request data from the host's host application and provide user data in response to the request data. The OTT connection 650 may transfer both the request data and the user data. The UE's client application may interact with the user to generate the user data that it provides to the host application through the OTT connection 650.

The OTT connection 650 may extend via a connection 660 between the host 602 and the network node 604 and via a wireless connection 670 between the network node 604 and the UE 606 to provide the connection between the host 602 and the UE 606. The connection 660 and wireless connection 670, over which the OTT connection 650 may be provided, have been drawn abstractly to illustrate the communication between the host 602 and the UE 606 via the network node 604, without explicit reference to any intermediary devices and the precise routing of messages via these devices.

As an example of transmitting data via the OTT connection 650, in step 608, the host 602 provides user data, which may be performed by executing a host application. In some embodiments, the user data is associated with a particular human user interacting with the UE 606. In other embodiments, the user data is associated with a UE 606 that shares data with the host 602 without explicit human interaction. In step 610, the host 602 initiates a transmission carrying the user data towards the UE 606. The host 602 may initiate the transmission responsive to a request transmitted by the UE 606. The request may be caused by human interaction with the UE 606 or by operation of the client application executing on the UE 606. The transmission may pass via the network node 604, in accordance with the teachings of the embodiments described throughout this disclosure. Accordingly, in step 612, the network node 604 transmits to the UE 606 the user data that was carried in the transmission that the host 602 initiated, in accordance with the teachings of the embodiments described throughout this disclosure. In step 614, the UE 606 receives the user data carried in the transmission, which may be performed by a client application executed on the UE 606 associated with the host application executed by the host 602.

In some examples, the UE 606 executes a client application which provides user data to the host 602. The user data may be provided in reaction or response to the data received from the host 602. Accordingly, in step 616, the UE 606 may provide user data, which may be performed by executing the client application. In providing the user data, the client application may further consider user input received from the user via an input/output interface of the UE 606. Regardless of the specific manner in which the user data was provided, the UE 606 initiates, in step 618, transmission of the user data towards the host 602 via the network node 604. In step 620, in accordance with the teachings of the embodiments described throughout this disclosure, the network node 604 receives user data from the UE 606 and initiates transmission of the received user data towards the host 602. In step 622, the host 602 receives the user data carried in the transmission initiated by the UE 606.

One or more of the various embodiments improve the performance of OTT services provided to the UE 606 using the OTT connection 650, in which the wireless connection 670 forms the last segment. More precisely, the teachings of these embodiments may improve the handling of colliding signals and/or channels and thereby provide benefits such as improving measurement latency and bypassing the measurement gap request procedure to improve positioning quality.

In an example scenario, factory status information may be collected and analyzed by the host 602. As another example, the host 602 may process audio and video data which may have been retrieved from a UE for use in creating maps. As another example, the host 602 may collect and analyze real-time data to assist in controlling vehicle congestion (e.g., controlling traffic lights). As another example, the host 602 may store surveillance video uploaded by a UE. As another example, the host 602 may store or control access to media content such as video, audio, VR or AR which it can broadcast, multicast or unicast to UEs. As other examples, the host 602 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 650 between the host 602 and UE 606, in response to variations in the measurement results. The measurement procedure and/or the network functionality for reconfiguring the OTT connection may be implemented in software and hardware of the host 602 and/or UE 606. In some embodiments, sensors (not shown) may be deployed in or in association with other devices through which the OTT connection 650 passes; the sensors may participate in the measurement procedure by supplying values of the monitored quantities exemplified above, or supplying values of other physical quantities from which software may compute or estimate the monitored quantities. The reconfiguring of the OTT connection 650 may include message format, retransmission settings, preferred routing etc.; the reconfiguring need not directly alter the operation of the network node 604. Such procedures and functionalities may be known and practiced in the art. In certain embodiments, measurements may involve proprietary UE signaling that facilitates measurements of throughput, propagation times, latency and the like, by the host 602. The measurements may be implemented in that software causes messages to be transmitted, in particular empty or ‘dummy’ messages, using the OTT connection 650 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

The above-described embodiments are intended to be examples only. Alterations, modifications and variations may be effected to the particular embodiments by those of skill in the art without departing from the scope of the description.

### ABBREVIATIONS

At least some of the following abbreviations may be used in this disclosure. If there is an inconsistency between abbreviations, preference should be given to how it is used above. If listed multiple times below, the first listing should be preferred over any subsequent listing(s).
1×RTT CDMA2000 1× Radio Transmission Technology
3GPP 3rd Generation Partnership Project
5G 5th Generation
6G 6^{th} Generation
ABS Almost Blank Subframe
ARQ Automatic Repeat Request
AWGN Additive White Gaussian Noise
BCCH Broadcast Control Channel
BCH Broadcast Channel
CA Carrier Aggregation
CC Carrier Component
CCCH SDU Common Control Channel SDU
CDMA Code Division Multiplexing Access
CGI Cell Global Identifier
CIR Channel Impulse Response
CP Cyclic Prefix
CPICH Common Pilot Channel
CPICH Ec/No CPICH Received energy per chip divided by the power density in the band
CQI Channel Quality information
C-RNTI Cell RNTI
CSI Channel State Information
DCCH Dedicated Control Channel
DL Downlink
DM Demodulation
DMRS Demodulation Reference Signal
DRX Discontinuous Reception
DTX Discontinuous Transmission
DTCH Dedicated Traffic Channel
DUT Device Under Test
E-CID Enhanced Cell-ID (positioning method)
eMBMS evolved Multimedia Broadcast Multicast Services
E-SMLC Evolved-Serving Mobile Location Centre
ECGI Evolved CGI
eNB E-UTRAN NodeB
ePDCCH Enhanced Physical Downlink Control Channel
E-SMLC Evolved Serving Mobile Location Center
E-UTRA Evolved UTRA
E-UTRAN Evolved UTRAN
FDD Frequency Division Duplex
FFS For Further Study
gNB Base station in NR
GNSS Global Navigation Satellite System
HARQ Hybrid Automatic Repeat Request
HO Handover
HSPA High Speed Packet Access
HRPD High Rate Packet Data
LOS Line of Sight
LPP LTE Positioning Protocol
LTE Long-Term Evolution
MAC Medium Access Control
MAC Message Authentication Code
MBSFN Multimedia Broadcast multicast service Single Frequency Network
MBSFN ABS MBSFN Almost Blank Subframe
MDT Minimization of Drive Tests
MIB Master Information Block
MME Mobility Management Entity
MSC Mobile Switching Center
NPDCCH Narrowband Physical Downlink Control Channel
NR New Radio
OCNG OFDMA Channel Noise Generator
OFDM Orthogonal Frequency Division Multiplexing
OFDMA Orthogonal Frequency Division Multiple Access
OSS Operations Support System
OTDOA Observed Time Difference of Arrival
O&M Operation and Maintenance
PBCH Physical Broadcast Channel
P-CCPCH Primary Common Control Physical Channel
PCell Primary Cell
PCFICH Physical Control Format Indicator Channel
PDCCH Physical Downlink Control Channel
PDCP Packet Data Convergence Protocol
PDP Profile Delay Profile
PDSCH Physical Downlink Shared Channel
PGW Packet Gateway
PHICH Physical Hybrid-ARQ Indicator Channel
PLMN Public Land Mobile Network
PMI Precoder Matrix Indicator
PRACH Physical Random Access Channel
PRS Positioning Reference Signal
PSS Primary Synchronization Signal
PUCCH Physical Uplink Control Channel
PUSCH Physical Uplink Shared Channel
RACH Random Access Channel
QAM Quadrature Amplitude Modulation
RAN Radio Access Network
RAT Radio Access Technology
RLC Radio Link Control
RLM Radio Link Management
RNC Radio Network Controller
RNTI Radio Network Temporary Identifier
RRC Radio Resource Control
RRM Radio Resource Management
RS Reference Signal
RSCP Received Signal Code Power
RSRP Reference Symbol Received Power OR
   Reference Signal Received Power
RSRQ Reference Signal Received Quality OR
   Reference Symbol Received Quality
RSSI Received Signal Strength Indicator
RSTD Reference Signal Time Difference
SCH Synchronization Channel
SCell Secondary Cell
SDAP Service Data Adaptation Protocol
SDU Service Data Unit
SFN System Frame Number
SGW Serving Gateway
SI System Information
SIB System Information Block
SNR Signal to Noise Ratio
SON Self Optimized Network
SS Synchronization Signal
SSS Secondary Synchronization Signal
TDD Time Division Duplex
TDOA Time Difference of Arrival
TOA Time of Arrival
TSS Tertiary Synchronization Signal
TTI Transmission Time Interval
UE User Equipment
UL Uplink
USIM Universal Subscriber Identity Module
UTDOA Uplink Time Difference of Arrival
WCDMA Wide CDMA
WLAN Wide Local Area Network

1. A method performed by a wireless device, the method comprising:
receiving configuration information associated with estimating and reporting transmission timing compensation;
estimating a transmission timing compensation for a time interval; and
transmitting a report including the estimated transmission timing compensation.

2. The method of claim 1, wherein the configuration information includes an indication of the time interval for estimating the transmission timing compensation.

3. The method of claim 2, wherein the indicated time interval is a time interval between a reception of a downlink (DL) positioning reference signal (PRS) and a transmission of an uplink (UL) sounding reference signal (SRS) by the wireless device.

4. The method of any one of claims 1 to 3, wherein the configuration information includes an indication of at least one SRS resource the wireless device should use for identifying the time interval for estimating the transmission timing compensation.

5. The method of claim 4, wherein the indication of the at least one SRS resource includes an SRS resource or a list of SRS resources associated with each target transmission/reception point (TRP).

6. The method of any one of claims 1 to 5, further comprising, identifying that the time interval for estimating the transmission timing compensation is a time interval between a reception of a DL PRS and a transmission of a UL SRS by the wireless device.

7. The method of any one of claims 1 to 6, further comprising, determining a UE Rx-Tx time difference measurement based on a reception time of a DL PRS.

8. The method of claim 7, wherein the report further includes the determined UE Rx-Tx time difference measurement.

9. The method of claim 7, wherein the time interval for estimating the transmission timing compensation is a time interval between the reception of the DL PRS used for UE Rx-Tx time difference measurement and a transmission time of a UL SRS.

10. The method of claim 9, wherein the configuration information indicates that, responsive to determining a UE Rx-Tx time difference measurement based on the DL PRS, the wireless device estimates the transmission timing compensation for the UE Rx-Tx time difference measurement and the associated SRS resource.

11. The method of any one of claims 1 to 10, further comprising, estimating a plurality of transmission timing compensations between a DL PRS resource and a plurality of UL SRS transmission instances.

12. The method of any one of claims 1 to 11, wherein estimating the transmission timing compensation includes estimating a difference in transmission timing between an end of the time interval and a start of the time interval.

13. The method of any one of claims 1 to 12, wherein the transmission timing compensation is estimated based on at least one of: a transmission timing adjustment made within the time interval, and/or a transmission timing estimate made within the time interval.

14. The method of any one of claims 1 to 13, further comprising, estimating an accuracy associated with the estimated transmission timing compensation.

15. The method of claim 14, further comprising, reporting the estimated accuracy.

16. A wireless device comprising a radio interface and processing circuitry configured to:
receive configuration information associated with estimating and reporting transmission timing compensation;
estimate a transmission timing compensation for a time interval; and
transmit a report including the estimated transmission timing compensation.

17. The wireless device of claim 16, wherein the configuration information includes an indication of the time interval for estimating the transmission timing compensation.

18. The wireless device of claim 17, wherein the indicated time interval is a time interval between a reception of a downlink (DL) positioning reference signal (PRS) and a transmission of a uplink (UL) sounding reference signal (SRS) by the wireless device.

19. The wireless device of any one of claims 16 to 18, wherein the configuration information includes an indication of at least one SRS resource the wireless device should use for identifying the time interval for estimating the transmission timing compensation.

20. The wireless device of claim 19, wherein the indication of the at least one SRS resource includes an SRS resource or a list of SRS resources associated with each target transmission/reception point (TRP).

21. The wireless device of any one of claims 16 to 20, further configured to identify that the time interval for estimating the transmission timing compensation is a time interval between a reception of a DL PRS and a transmission of a UL SRS by the wireless device.

22. The wireless device of any one of claims 16 to 21, further configured to determine a UE Rx-Tx time difference measurement based on a reception time of a DL PRS.

23. The wireless device of claim 22, wherein the report further includes the determined UE Rx-Tx time difference measurement.

24. The wireless device of claim 22, wherein the time interval for estimating the transmission timing compensation is a time interval between the reception of the DL PRS used for UE Rx-Tx time difference measurement and a transmission time of a UL SRS.

25. The wireless device of claim 24, wherein the configuration information indicates that, responsive to determining a UE Rx-Tx time difference measurement based on the DL PRS, the wireless device estimates the transmission timing compensation for the UE Rx-Tx time difference measurement and the associated SRS resource.

26. The wireless device of any one of claims 16 to 25, further configured to estimate a plurality of transmission timing compensations between a DL PRS resource and a plurality of UL SRS transmission instances.

27. The wireless device of any one of claims 16 to 26, wherein estimating the transmission timing compensation includes estimating a difference in transmission timing between an end of the time interval and a start of the time interval.

28. The wireless device of any one of claims 16 to 27, wherein the transmission timing compensation is estimated based on at least one of: a transmission timing adjustment made within the time interval, and/or a transmission timing estimate made within the time interval.

29. The wireless device of any one of claims 16 to 28, further configured to estimate an accuracy associated with the estimated transmission timing compensation.

30. The wireless device of claim 29, further configured to report the estimated accuracy.

31. A method performed by a network node, the method comprising:
transmitting, to a wireless device, configuration information associated with estimating and reporting transmission timing compensation;
receiving, from the wireless device, a transmission timing compensation for a time interval; and
estimating a round trip time (RTT) based at least in part on the received transmission timing compensation.

32. The method of claim 31, wherein the configuration information includes an indication of the time interval for estimating the transmission timing compensation.

33. The method of claim 32, wherein the indicated time interval is a time interval between a reception of a downlink (DL) positioning reference signal (PRS) and a transmission of an uplink (UL) sounding reference signal (SRS) by the wireless device.

34. The method of any one of claims 31 to 33, wherein the configuration information includes an indication of at least one SRS resource the wireless device should use for identifying the time interval for estimating the transmission timing compensation.

35. The method of claim 34, wherein the indication of the at least one SRS resource includes an SRS resource or a list of SRS resources associated with each target transmission/reception point (TRP).

36. The method of any one of claims 31 to 35, further comprising, receiving at least one of: a UE Rx-Tx time difference measurement, and/or a gNB Rx-Tx time difference measurement.

37. The method of claim 36, further comprising, estimating the RTT based at least in part on the gNB Rx-Tx time difference measurement, the UE Rx-Tx time difference measurement, and/or the transmission timing compensation.

38. The method of any one of claims 31 to 37, further comprising, estimating a position of the wireless device based at least in part on the estimated RTT.

39. The method of any one of claims 31 to 38, further comprising, receiving an estimated accuracy associated with the transmission timing compensation.

40. The method of claim 39, further comprising, estimating a position of the wireless device based at least in part on the estimated RTT and the estimated accuracy associated with the transmission timing compensation.

41. A network node comprising a radio interface and processing circuitry configured to:
transmit, to a wireless device, configuration information associated with estimating and reporting transmission timing compensation;
receive, from the wireless device, a transmission timing compensation for a time interval; and
estimate a round trip time (RTT) based at least in part on the received transmission timing compensation.

42. The network node of claim 41, wherein the configuration information includes an indication of the time interval for estimating the transmission timing compensation.

43. The network node of claim 42, wherein the indicated time interval is a time interval between a reception of a downlink (DL) positioning reference signal (PRS) and a transmission of an uplink (UL) sounding reference signal (SRS) by the wireless device.

44. The network node of any one of claims 41 to 43, wherein the configuration information includes an indication of at least one SRS resource the wireless device should use for identifying the time interval for estimating the transmission timing compensation.

45. The network node of claim 44, wherein the indication of the at least one SRS resource includes an SRS resource or a list of SRS resources associated with each target transmission/reception point (TRP).

46. The network node of any one of claims 41 to 45, further configured to receive at least one of: a UE Rx-Tx time difference measurement, and/or a gNB Rx-Tx time difference measurement.

47. The network node of claim 46, further configured to estimate the RTT based at least in part on the gNB Rx-Tx time difference measurement, the UE Rx-Tx time difference measurement, and/or the transmission timing compensation.

48. The network node of any one of claims 41 to 47, further configured to estimate a position of the wireless device based at least in part on the estimated RTT.

49. The network node of any one of claims 41 to 48, further configured to receive an estimated accuracy associated with the transmission timing compensation.

50. The network node of claim 49, further configured to estimate a position of the wireless device based at least in part on the estimated RTT and the estimated accuracy associated with the transmission timing compensation.
